(19) United States
(12) Patent Application Publication
(10) Pub. No.: US 2006/0235884 A1
(43) Pub. Date: Oct. 19, 2006

(54) System and method for evaluating talent and performance

(75) Inventors: David T. Pfenninger, Carmel, IN (US); Douglas R. G. White, Carmel, IN (US); Edwin P. Frederici, Carmel, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Performance Assessment Network, Inc., Carmel, IN (US)

(21) Appl. No.: 11/108,551

(22) Filed: Apr. 18, 2005

(51) Int. Cl. G06F 17/00

(52) U.S. Cl. 707/104.1

(57) ABSTRACT

A system and method for evaluating talent and performance comprises a central computer in communication with a plurality of network computers. The central computer is operable to provide a plurality of user workspaces accessible at the plurality of network computers. In one embodiment, a plurality of hiring stages are defined for a job opening and job applicants pass through the hiring stages from a job application stage to a job offer stage. The central computer calculates statistical information such as probabilities that an applicant will pass through the hiring stages, typical time durations for applicants to pass through the hiring stages, the total number of job candidates that have applied for the job opening, and a ranking of the candidates. The system is operable to determine that a warning condition exists related to a job opening and display such warning on one of the plurality of user workspaces.

### BACKGROUND

This invention relates to the field of human assessment, and particularly to automated computerized systems designed to evaluate talent and performance of individuals. In one embodiment, the invention is a human resources solution designed to assist organizations in hiring new employees.

Individuals are continually assessed, tested, measured and/or otherwise evaluated by others during their lives. Such evaluations typically begin very early with parents assessing their newborns and infants relative to others. School aged children and young people are frequently graded both formally and informally based on their performance in school. At working age, employers periodically review the on-the-job performance of their employees to determine which workers should be promoted and/or receive a bonus.

In addition to assessing existing employees, businesses and other organizations also assess job candidates to determine which applicants will be a good fit for a particular job opening. The human resources (HR) departments of these organizations spend significant amounts of money and time recruiting, interviewing and hiring job candidates (also referred to herein as job “applicants”). To some extent, these expenses are unavoidable, as it is imperative to the success of the company to attract and hire well qualified and talented candidates. However, the traditional process of recruiting, interviewing and hiring job candidates includes a number of problems and inefficiencies.

One common problem in the human evaluation process is effective tracking of individuals through the evaluation process. For example, in HR departments responsible for evaluating large numbers of job applicants, it is difficult to effectively track and compare the progress of candidates through the hiring process. Candidates may be required to pass a number of milestones before an offer is given, such as initial screenings, psychological testing, in-person interviews, and background checks. If a large number of candidates are being considered, those in charge of hiring will have a difficult time remembering where individual candidates stand in the hiring process. One promising candidate may be at a relatively early testing stage in the hiring process while another promising candidate may have completed all interviews. There may have been a large number of marginal candidates who have progressed relatively far into the process while another large number of promising candidates are only beginning in the process. Without a clear picture of where all candidates stand in the hiring process along with an indication of the desirability of the numerous candidates, it may be difficult to make an informed hiring decision. Although this information may be manually assembled and placed in a report, it would be desirable to provide a system for automatically tracking the progress of candidates through the hiring process in real time, and providing an assessment of the candidates relative to one another, without the need for an HR person to continually update the information.

Another common problem with many evaluation systems is that a particular conclusion on an individual may be reached at an improper time. For example, in HR departments, hiring decisions may be made too early or too late for particular candidates. Offers made too early in the process could mean that better suited candidates for the job were passed over. Offers made too late could mean that well suited candidates became frustrated with the hiring process and accepted other job offers. Also, some jobs need to be filled by a certain deadline to continue smooth operation of the organization. If these positions are not filled by the deadline, significant problems may result for the organization, causing other employees to be distracted from their primary responsibilities as they pick up additional responsibilities of the vacant position. Therefore, it would be desirable to provide a system for selecting job candidates that will assist a hiring manager in making a hiring decision at a proper time.

In addition to reaching conclusions at an improper time, another problem with typical HR evaluation systems is that evaluation standards and procedures tend to be inconsistent. For example, in most HR systems, job candidates are interviewed by a number of individuals who ask the same unstructured questions. The result is that little additional information is discovered about the candidate during the hiring process other than the initial impressions made on each interviewer. Furthermore, each interviewer scores the candidate by his or her own subjective standards, making it difficult for the HR department to get an accurate picture of the candidate. Therefore, it would be desirable to provide a system capable of guiding interviewers with scheduled questions during the interview process, insuring that each interviewer accomplishes a different goal. It would also be desirable to provide a system capable of providing some level of objectivity to each interviewer's subjective scoring standards.

Yet another problem with the typical evaluation process is scheduling of parties for participation in the individual evaluation steps of the hiring process. For example, a HR department will need to schedule numerous parties for interviews, testing, and other meetings. It is often a logistical nightmare for a HR department to schedule an interview for a candidate with all the various decision makers for a particular job. In particular, the HR department must determine a convenient day for the candidate to interview as well as convenient times for each of the interviewers on that particular day. Therefore, it would be desirable to provide an HR system capable of automatically scheduling interviews and other meetings amongst various participants.

Another aspect of many evaluation systems includes participation in standardized testing. When standardized testing is required, it is often inconvenient for the party being evaluated to find time to participate in the standardized testing. For example, many job applicants will be busy with their own current jobs during the working day, and it may be difficult for the applicant to find significant amounts of time during the working day to make himself or herself available for standardized testing. Also, geographical and time considerations may make it very inconvenient for the candidate to be present at the employer's facility for any more than a single day of testing or interviewing. Therefore, it would be desirable to provide a system that allows candidates to participate in standardized testing on-line from remote locations at various times during the day when participating in the hiring process.

In any process designed to assess human performance, a series of steps must be conducted by the assessing party. This series of steps may be as simple as watching a person's performance and then making an immediate assessment of the performance. In the case of a hiring process, the steps typically include an initial application step, a final offer step, and a number of steps in between. However, for any organization, the hiring process is likely to differ significantly with regard to the steps between application and offer. For example, some job positions may require only a single interview step, while other positions may require a second or even a third interview step. Furthermore, for certain extremely desirable job candidates, it may be possible to cut out a number of the intermediate steps. This is especially true when the candidate is identified very early as an extremely desirable job candidate. Therefore, it would be desirable to provide an evaluation system that is dynamic and open with respect to the hiring process, allowing the organization to change the hiring process from job-to- job or candidate-to-candidate.

Several companies currently offer computer software products designed to assist HR departments in efficiently and effectively hiring new candidates. However, these systems typically do not include solutions to the above-described problems. For example, these existing software products are not “open systems” and do not seamlessly integrate third party content into their systems. In particular, these software products do not make professional standardized third party testing solutions available to HR departments for distribution to job applicants. As another example, existing HR software products do not provide automated warning systems to help HR departments make hiring decisions at the proper time.

Based on the foregoing, it would be desirable to provide a system for evaluating human talent and performance including one or more of the features mentioned above. For example, in the HR context, it would be desirable to provide a tracking, assessment and selection system capable of tracking all job applicants through various steps of a hiring process. It would also be desirable to rank the applicants based upon performance during various steps of the hiring process. Furthermore, it would be desirable to provide an automated candidate evaluation system capable of importing data from and exporting data to third party content providers, allowing all data within the HR department to be shared and effectively utilized by those using the system. In addition, it would be desirable to provide a candidate tracking, assessment and selection system operable to inform HR departments of the proper time to proceed forward with a job offer. It would also be desirable to provide an evaluation system where the organization has the ability to adapt the hiring process from job-to-job and candidate-to-candidate. Yet another advantage would be to provide an automated evaluation system operable to efficiently schedule candidates and existing employees to participate in various steps of the hiring process.

### SUMMARY

A system and method for evaluating talent and performance comprises a central computer in communication with a plurality of network computers, including in- house computers and remote computers. The central computer is operable to provide a plurality of user workspaces that may be accessed at the plurality of network computers.

In one embodiment, the system and method is used to evaluate job applicants for a job opening. In this embodiment, a plurality of hiring stages are defined and the job applicants are passed through the hiring stages, with applicants removed from the hiring process in different hiring stages, until a desirable job applicant is identified. To this end, the system comprises at least one memory containing data related to the job opening, the plurality of hiring stages, and the plurality of job applicants. The central computer calculates statistical information related to the job opening stored in memory. The statistical information is also retained within the memory. The statistical information may include, for example, probabilities that any given applicant will pass through the individual hiring stages as well as the plurality of hiring stages. As another example, the statistical information includes typical time durations for applicants to pass through the entire hiring process as well as typical time durations to pass through the individual steps of the hiring process. As yet another example, the statistical information includes the total number of candidates that have applied for the job opening and a ranking of the candidates.

The central computer communicates with the at least one memory and the network computers to provide different individual user workspaces, such as workspaces in an applicant environment, workspaces in a hiring manager environment, and workspaces in a human resources environment. Different information is available to different users through their individual workspaces. However, data input in one of the plurality of workspaces may be accessed by a user in a different workspace, if appropriate. For example, a scheduler interacts with workspaces in all environments to allow applicants and interviewers to easily schedule interviews and other appointments.

In the applicant environment, individuals may access the system using a remote computer and apply for one or more job openings. After applying for a job or otherwise providing personal information, a unique workspace is created for the applicant. The applicant is provided with a username and password to access his or her unique workspace. Through the applicant's workspace, the applicant is provided with information concerning the job openings he or she has applied for as well as the applicant's current status with respect to such job openings. In addition, the applicant is provided with the ability to receive messages from the organization, and schedule tests, interviews, background checks or other application related activities.

In the hiring manager environment, a hiring manager for the organization is provided with a workspace unique to the hiring manager. The hiring manager's workspace allows the hiring manager to view information about the applicants that have applied for a job opening the hiring manager is responsible for. The information available to the hiring manager may include, for example, detailed information about various job openings, detailed information about applicants for such job openings, instructions for conducting interviews, rankings of the job applicants, and other statistical information about the job opening.

In the HR environment, global information is generally available concerning all job openings within the organization and all applicants for such jobs. The HR environment provides employees in the organization's human resources department with powerful tools for moving job applicants through the hiring process. For example the HR environment allows for scheduling of meetings and interviews, general tracking of applicants through the hiring process, creation of new job openings, customization of the hiring process associated with each job, and automated warnings when a potential problem exists with one of the job openings.

In one embodiment, the system is operable to determine whether a warning situation exists related to one of the job openings for the organization. In this embodiment, the system displays a list of job openings in a human resources workspace. The system is operable to provide a warning associated with one of the displayed job openings when the central computer determines that the warning situation exists. In one exemplary warning situation the central computer determines, based on the calculated probability of passing through the. plurality of hiring stages and the total number of job applicants, that a likelihood exists that at least one of the plurality of job applicants will not pass through the plurality of hiring stages. In another exemplary warning situation, the central computer determines, based on the calculated typical time duration to pass through the plurality of hiring stages, that a likelihood exists that one of the plurality of job applicants will have insufficient time to pass through the plurality of hiring stages before a deadline. In yet another exemplary warning situation, the central computer determines that at least one highly ranked candidate is unlikely to complete the hiring process unless the highly ranked candidate is fast tracked through the hiring process.

In another embodiment, the system is open and allows for content sharing with third party content providers, regardless of the format of the third party content providers. In addition, the system may be configured such that content sharing may apply to any of a number of different stages of the hiring process. For example, the open content feature of the system may not be limited to a testing stage, but may also apply to a background check stage.

In yet another embodiment, the hiring stages configured for any given job opening are adaptable. In this embodiment, one applicant may encounter different steps from application-to-offer than a different applicant. To this end, the system reviews each applicant's performance in various hiring stages to determine the next appropriate hiring stage for the applicant.

The above embodiments and features of the system and method for evaluating talent and performance will be understood in further detail with respect to the figures referenced below and the accompanying description.

### BRIEF DESCRIPTION OF THE DRAWINGS

FIG. 1 shows an exemplary hiring process that may be used with the system and method for evaluating talent and performance described herein;

FIG. 2A shows a computerized system for assessing and selecting job candidates;

FIG. 2B shows a graphical representation of various working environments offered through a server of the computerized system of FIG. 2A;

FIG. 3 shows an exemplary applicant home page of the computerized system of FIG. 2A;

FIG. 4A shows an exemplary application page of the computerized system of FIG. 2A;

FIG. 4B shows an exemplary alternative application page of the computerized system of FIG. 2A;

FIG. 5 shows an exemplary application report page of the computerized system of FIG. 2A;

FIG. 6 shows an exemplary scheduler page of the computerized system of FIG. 2A;

FIG. 7 shows the exemplary applicant home page of FIG. 3 after applying an applicant has applied for an additional job opening.

FIG. 8 shown an exemplary hiring manager overview page of the computerized system of FIG. 3;

FIG. 9 shows an exemplary interview page of the computerized system of FIG. 2A;

FIG. 10 shows an exemplary openings page of the computerized system of FIG. 2A;

FIG. 11 shows an exemplary job description page of the computerized system of FIG. 2A;

FIG. 12A shows another exemplary job descriptions page of the computerized system of FIG. 2A;

FIG. 12B shows additional information that may be provided through the job descriptions page of FIG. 12A;

FIG. 13A shows an example of calculation of an average weighted candidate score using the computerized system of FIG. 2A;

FIG. 13B shows an interviewer score page of the computerized system of FIG. 2A;

FIG. 13C shows an interviewer statistics page of the computerized system of FIG. 2A;

FIG. 14 shows an exemplary HR openings page of the computerized system of FIG. 2A;

FIG. 15 shows an exemplary ranked candidate page of the computerized system of FIG. 2A;

FIG. 16 shows an exemplary applicant detail page of the computerized system of FIG. 2A;

FIG. 17 shows a block diagram of the steps taken by the computerized system of FIG. 2A when determining appropriate warnings for a best candidate probability indicator;

FIG. 18 shows an exemplary probability calculation of the best candidate probability indicator referenced in FIG. 17;

FIG. 19 shows a process flow for the interaction between the central computer of FIG. 2A and a user in an applicant environment;

FIG. 20 shows a process flow for the actions taken by the computerized system of FIG. 2A when cooperating with third party content providers;

FIG. 21 shows a flow chart of an exemplary subroutine used by the system of FIG. 2A for cross-selling applicants additional job openings.

### DESCRIPTION

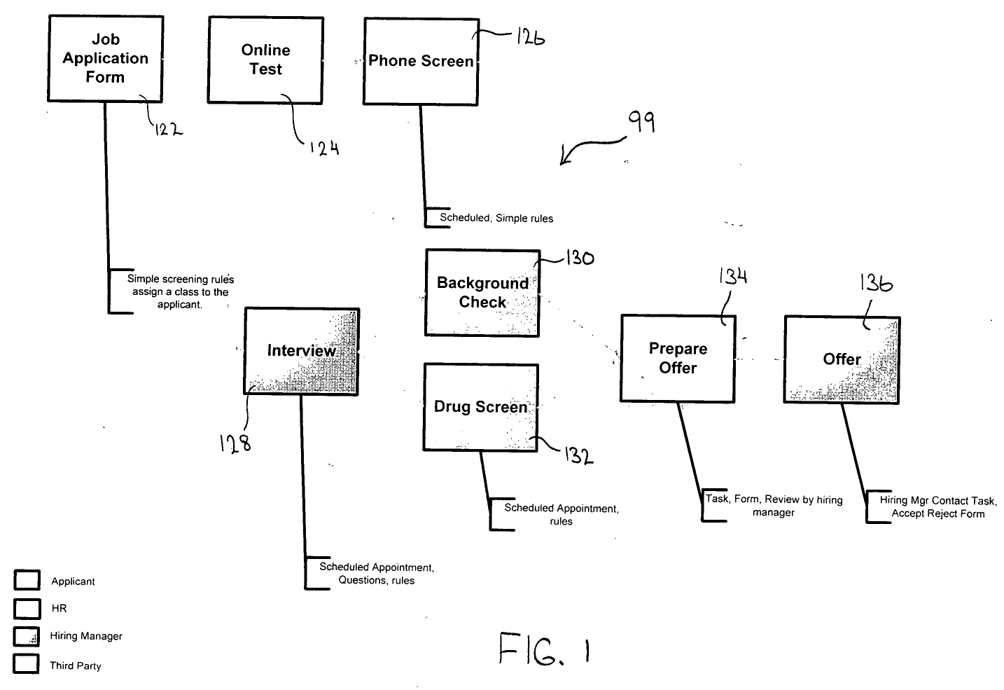

A system and method for evaluating talent and performance will now be described with reference to an exemplary human resources system for assessing and selecting job candidates. FIG. 1 shows a high-level block diagram of a series of exemplary steps a job applicant must take in an exemplary hiring process 99. This series of steps is designed for use with the computerized system for assessing and selecting job applicants. Each step of the hiring process may also be referred to herein as a “stage” or a “node” in the hiring process.

The method for assessing and selecting job applicants 99 begins with a job applicant completing an online job application form, as noted in step 122 of FIG. 1. After completing an online job application from, the candidate is asked to take an online test in step 124. This online test is designed to determine whether the job applicant meets certain requirements for the job position. If the results of the on-line test are positive, a telephone interview with the applicant is arranged, as noted in step 126, to further screen the applicant. If the results of the phone screen are positive, a personal interview session is scheduled with the applicant, as noted in step 128. If the decision is made to hire the applicant following the interview step, a background check 130 is performed and the applicant is asked to pass a few final tests, such as a drug test 132. If the applicant passes these tests, the organization prepares an offer in step 134. The offer is reviewed by relevant parties within the organization and is then delivered to the applicant in step 136.

The steps described above may be automatically adjusted by the system described herein from job-to-job or from individual-to-individual. For example, depending upon the job, the exemplary hiring process 99 may include a background check step before any interview step. As another example, certain jobs may include one or more additional steps in the hiring process. For example, a manual step for HR review of certain job applicants may be inserted before the telephone interview. This HR review step may be implemented allow the HR department to reject certain applicants that do not conform to the desired candidate profile at a particular time for any of a number of reasons not otherwise identified by the system. For example, if the company has a target of employing at least 25% female employees, and the company is currently below or just at its target, a male applicant may be passed over to allow a slightly lower ranked but fully qualified female applicant to receive an offer. In any event, the ability to conform the hiring process to different job openings and/or different candidates provides unique advantages to organizations using the system and method described herein.

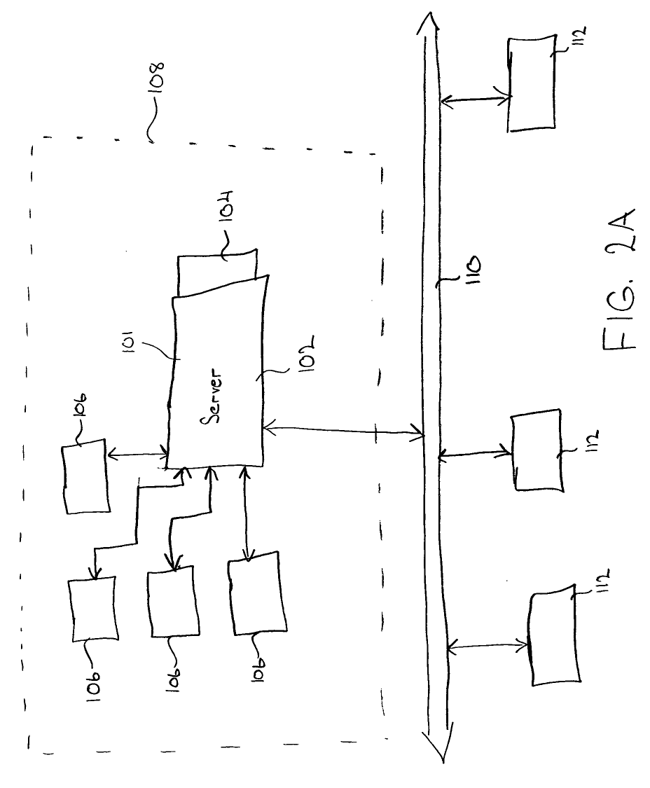

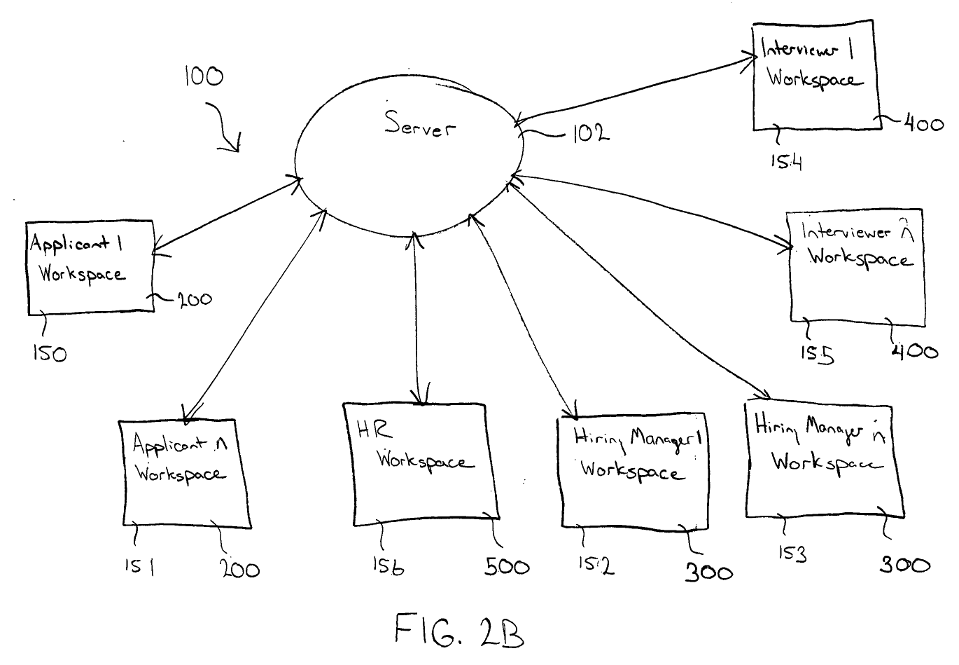

With reference now to FIG. 2A, the computerized system for assessing and selecting job candidates 100 includes at least one central computer 101 comprising a server 102. The server 102 is in communication with a memory 104 operable to store data. The server 102 is also in communication with a plurality of network computers, including “in-house” computers 106 and “remote” computers 112. The “in-house” computers 106 are generally located in the offices of the organization (as indicated by dotted line 108). These in-house computers 106 are all connected to the server using a local area network. The “remote” computers 112 are generally located away from the organization's offices. The server 102 is in contact with these remote computers 112 via the Internet 110. Although FIG. 2A shows the central computer 101 and server 102 located within the offices of the organization 108, the server and/or central computer may alternatively be placed in a remote location and in communication with the offices of the organization via the Internet 110.

With reference to FIG. 2B, the server 102 provides several different user “workspaces” 150-156 available to users of the system. Each different user workspace comprises a plurality of “screen views” or “web pages” accessible to the user. The data available through each user workspace 150-156 is unique to the individual and/or his or her position within the organization. To this end, each user of the system is granted a clearance which determines what data is available to the user through his or her workspace 150-156. Although FIG. 2B shows seven different workspaces, an unlimited “n” number of additional workspaces are contemplated, as represented by applicant “n” workspace 151, hiring manager “n” workspace 153, and interviewer “n” workspace 155. Of course, there many also be an unlimited number of HR workspaces, although this is not shown in FIG. 2B.

As shown in FIG. 2B, each user workspace 150-156 may be classified in one of a plurality of working environments. In FIG. 2B, the plurality of working environments include an applicant environment 200, a hiring manager environment 300, an interviewer environment 400, and a human resources (HR) environment 500. However, the system 100 may include a number of different or additional environments for other users. The different working environments generally provide a template for the look and feel of user workspaces within the environment as well as the type of general data available through the environment. For example, job applicants using workspaces in the applicant environment 200 are generally limited to viewing data related to their personal profile, interview schedule, and personal progress through the hiring steps. Users of such workspaces in the applicant environment 200 are restricted from viewing information about other job applicants or their standing with respect to such other applicants. Furthermore, users of workspaces in the applicant environment 200 are restricted from details about their performance during any particular phase of the hiring process. As another example, users of workspaces in the hiring manager environment 300 may be provided with nearly complete access to information related to applicants who have applied for jobs that are the responsibility of the hiring manager, but will be restricted from access to information related to applicants that are not the responsibility of the hiring manager. In the HR environment 500, one or more user workspaces may be granted full access to all information in the system.

Each user workspace 150-156 may be accessed by the user at one of the in-house computers 106 and/or one of the remote computers 112. The user's unique environment is accessible upon entry of a valid user name and password.

The Applicant Environment

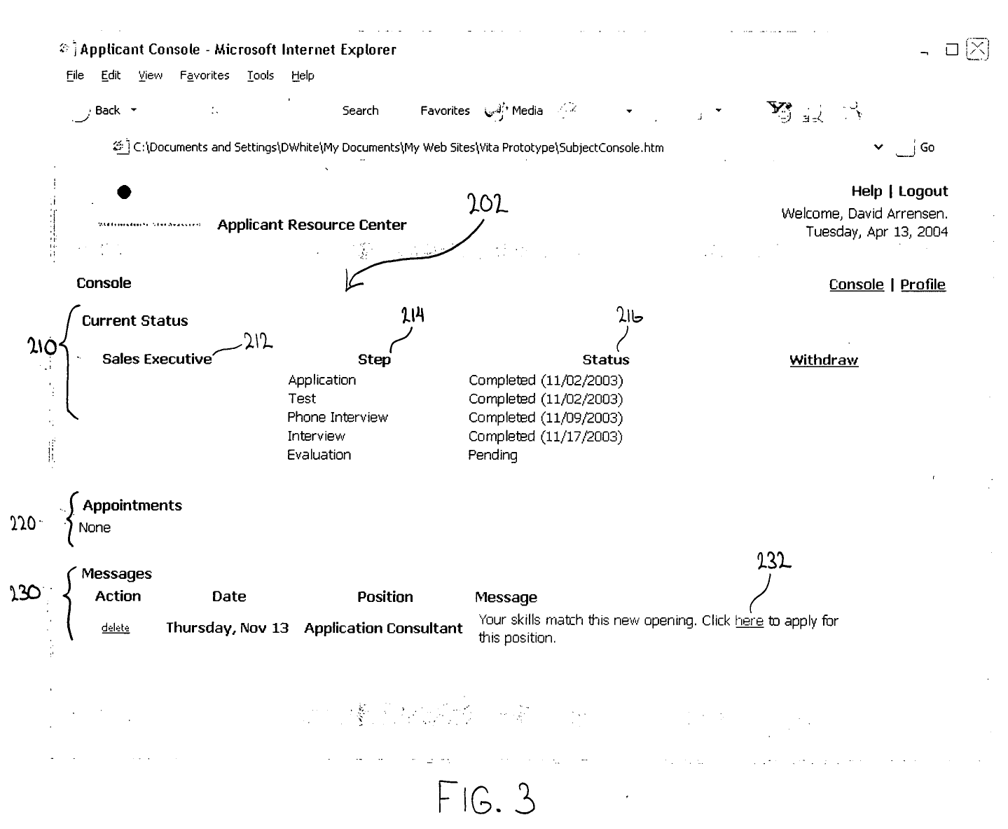

With reference to FIGS. 3-7, several pages of an exemplary job applicant workspace 150 within the applicant environment 200 are shown. A new job applicant workspace is automatically created by the system 100 when a potential employee logs on to the organization web site and submits and online resume. The online resume is a form that asks basic information and history of the applicant, similar to the information that would typically be provided on a paper resume. This information may be very basic and only include data such as a name, address, telephone number, and e-mail, but may also be more in-depth to include data that might be provided on a traditional resume, such as job history, education, etc. With this information, the system creates a profile for the applicant and a new applicant workspace. A username and password for the applicant is then delivered to the applicant by e-mail or paper mail. In an alternative embodiment, the system does not require an on-line resume, but instead provides a username and password after an applicant completes an on-line application for a job, provided the user does not already have a username and password.

With a username and password in hand, the applicant visits to the organization's website using a remote computer and enters the username and password in the designated log-in location. If the system recognizes the username and password, the server provides the applicant with access to his or her applicant workspace through the applicant's remote computer.

FIG. 3 shows an exemplary applicant workspace for an exemplary applicant named David Arrensen. As shown in FIG. 3, workspaces in the applicant environment 200 include an applicant home page 202. The applicant home page includes a “current status” block 210, an “appointments” block 220, and a “messages” block 230.

All jobs applied for by the applicant are listed under the current status block 210. In FIG. 3, the applicant has applied for a sales executive position, as noted by reference numeral 212. Steps completed by the applicant toward receipt of a job offer are listed under the heading “step” 214 along with any steps currently pending in the process. In addition, the status of each step is listed under the heading “status” 216. FIG. 3 shows that the applicant has applied for a sales executive job, completed an online test, completed a phone interview, participated in in-house interviews, and is awaiting evaluation from the in-house interviews. If the step is completed, the date of completion of the step is listed next to the word “completed” under the status heading 216. Should the interview evaluation produce favorable results, the system will automatically list the next step in the process, such as “second interview”, “background check” or “drug screen”, and list “pending” next to this new step until the step is completed. Accordingly, the applicant is continually provided with up-to-date information concerning his or her standing in the job application process. A “withdraw” option 218 is also provided in the current status block 210. The withdraw option 218 allows the applicant to immediately remove his or her name from further consideration at any time during the application process.

An appointments block 220 is provided under the current status block 210 on the applicant home page 202. The appointments block 220 lists any upcoming appointments for the applicant, such as upcoming interviews. In this case, as shown in FIG. 3, the applicant currently has no appointments scheduled.

A messages block 230 is provided under the appointments block 220 on the applicant home page 202. The messages block list messages to the applicant from the organization. The messages block 230 lists the date of the message, the position to which the message relates, and the text of the message. In this case, as shown in FIG. 3, a message is provided to the applicant informing him that his skill set matches a new job opening, and the applicant is invited to apply for the position. A link 232 is provided to allow the applicant to go directly to the application page for the Application Consultant position. Should additional positions open in the future that match the applicant's skill set, based on the resume information, a new message will be listed inviting the applicant to also apply for that position. Of course, additional messages may also be provided in the message block 230. For example, the applicant may be informed that a particular position has been filled by another person, and the applicant was not accepted for that position. As another example, a job offer may be communicated to the applicant through the message block 230. When the text of the message is too long to conveniently fit in the message block, a link is listed in the message block. Once the applicant clicks the link, the applicant is directed to a new page that includes the entire message text.

As mentioned above, FIG. 3 shows the applicant home page 202 with a message that tells the applicant that his skills match a new opening. These messages informing applicants of potential positions of interest are automatically created by the system when a match is identified between an applicant who has completed an online resume and a vacant job position that has been entered into the system by someone within the organization. To this end, the central computer includes an algorithm that matches job positions with qualified applicants, and automatically sends a message to qualified applicants informing the applicant of the new position. This algorithm runs periodically or when a new applicant or new job position is entered into the system.

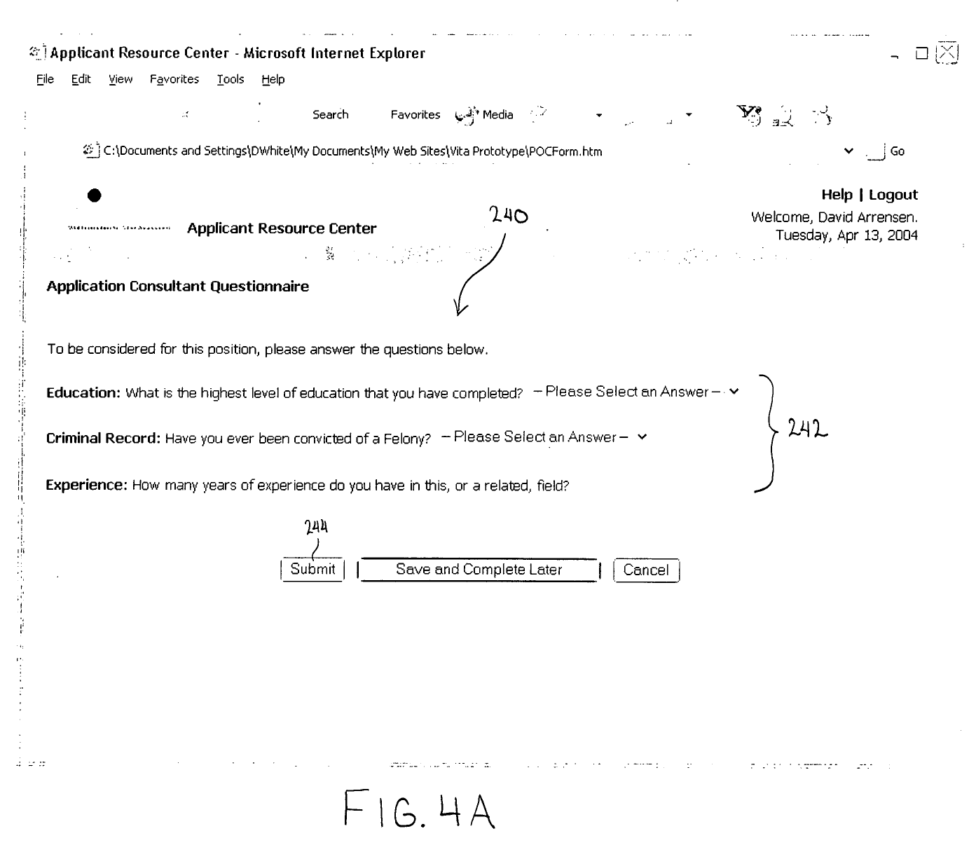

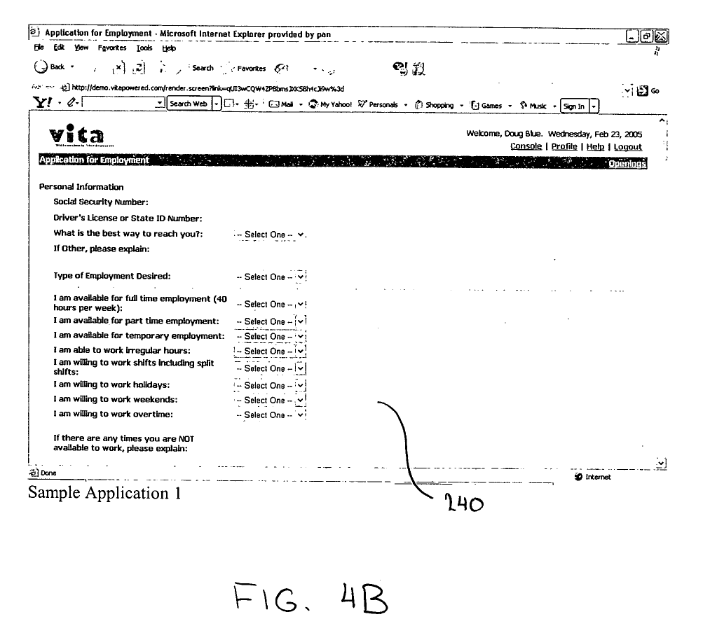

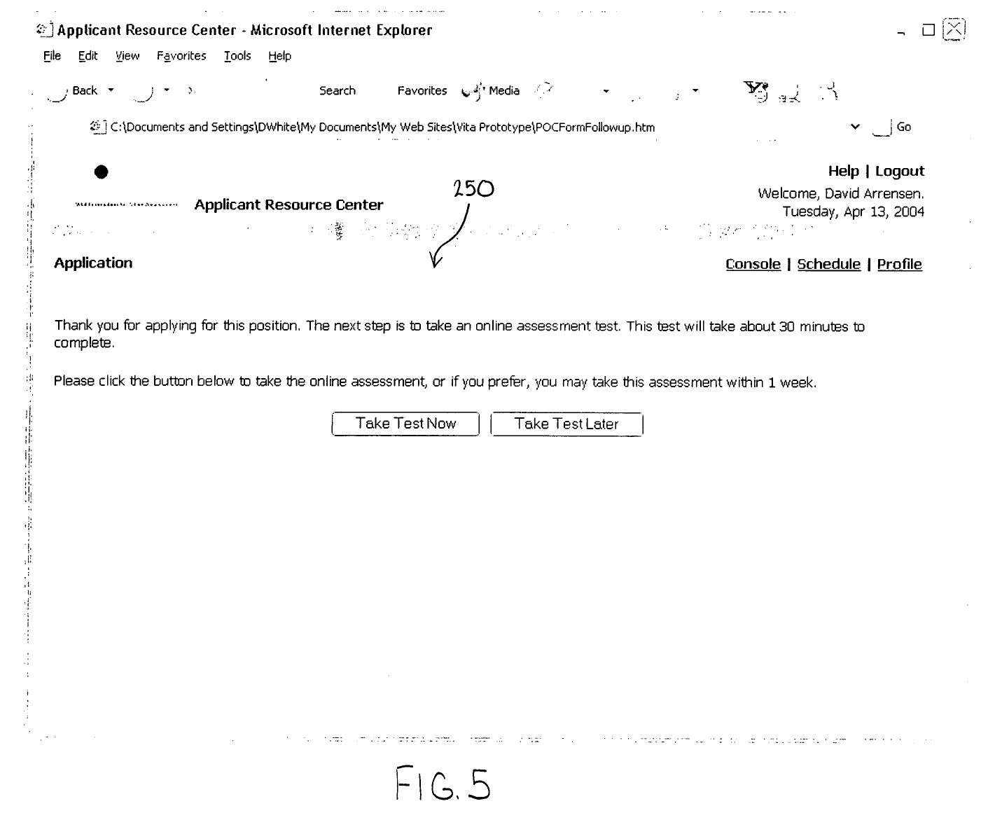

When the applicant views the message on the applicant home page 202 informing the applicant of a new opening, the applicant may click the link 232 included with the message to apply for the job position. After clicking this link 232, the applicant is directed to an online application page. An exemplary application page 240 is shown in FIG. 4A. The application page 240 includes a questionnaire 242 designed to screen out unqualified applicants. For example, if the position requires a certain level of education or a certain number of years of experience in a certain field, the applicant is asked to answer questions related to these topics. After answering these questions, the applicant submits the answers using a “submit” button 244. The central computer then determines whether the applicant is qualified for the position and immediately informs the applicant of his or her qualification status on an application report page 250, such as that shown in FIG. 5. Depending upon the information desired by the organization at the application stage, the application page 240 may include more detailed questions and/or additional questions, such as those shown in FIG. 4B.

In the event the applicant is not qualified for the position after completing the questionnaire 242 on the application page 240 of FIG. 4, the applicant is thanked for his or her interest on an application report page and then redirected to the applicant home page 202. However, if the applicant is qualified, the applicant is informed on the application report page that the next step in the process is to take an online assessment test. The applicant is notified that the online assessment test will take an approximate amount of time to complete, and the applicant is asked whether he or she wishes to take the test now or at a later time. If the applicant wishes to take the online assessment test now, the applicant is passed on to the online screening test. If the applicant wishes to take the test later, the applicant is directed back to the applicant home page 202, and a message is displayed in the message block 230 indicating that the applicant needs to complete an online assessment before moving forward in the application process for the indicated position.

The online assessment test may take the form of numerous different types of tests. For example, the online assessment may be a standardized test such as mental and physical abilities tests, proficiency tests, biodata inventories, and personality inventories. These standardized tests can provide valuable information on an applicant such as general cognitive abilities, language skills, math skills, personality profiles, and/or likes and dislikes. The information gathered from such tests is then used by the system to identify the individuals that are most likely to be a good match for the job position being filled. For example, human resources may determine that a particular job calls for an extroverted personality with good verbal skills, and this may be identified when the job description is entered into the system 100. Applicants for such job may be given a personality inventory, and candidates identified as having introverted personality types may be filtered from further consideration by the system. In addition to standardized tests, companies may create their own online assessments for particular jobs. For example, a company may create its own specialized assessment to test visual perception skills. As another example, a company may create a specialized technical test for applicants for an engineering position. Numerous applicants may be automatically removed from consideration if their score on the specialized assessment test is not greater than a minimum threshold score.

In order to provide online assessments for each position, the system is equipped with automated testing functionality. An example of a computerized system providing such functionality is described in U.S. Pat. No. 6,681,098, which is incorporated herein by reference in its entirety. The automated testing functionality may be provided by the central computer alone or may be included as part of a network with one or more other computers. For example, the central computer may connect to a remote server using the Internet in order to obtain standardized tests and deliver such tests to the applicant as part of the application process.

In one embodiment, the human resources department of the organization employs at least one testing professional having certain professional qualifications that allow the professional to give certain standardized tests to third parties. In this embodiment, before a standardized test is given to the applicant, the testing professional orders one or more desired standardized tests from an outside agency for certain job applicants showing high potential. For example, the testing professional may order five standardized reading comprehension tests to distribute to the top five candidates in an attempt to determine which candidate has the highest reading comprehension abilities. The testing professional may then use the system 100 to deliver a message to each applicant designated to take the reading comprehension test. Each message includes a link to a website and a username and password for obtaining the test through the website. When the applicant views the message through the applicant home page and clicks on the link, the third party testing site is framed within the applicant workspace 150. The applicant may then use the username and password provided to the applicant in order to access the test. After completing the test, the test results are scored delivered to the organization for review by the testing professional and appropriate analysis before a judgment is made on the applicant.

In situations like the one described in the preceding paragraph, test results from the online assessment may not be immediately available following an applicant's completion of the online assessment. However, in other situations, the results of the online assessment are automatically scored or analyzed. In either event, upon completion of the online assessment, the applicant will be thanked for participating in the online assessment and directed back to the applicant home page 202 to await a response concerning the online assessment. If the online assessment was not immediately scored a new message is automatically provided in the message block 230 of the applicant home page 202 informing the applicant that the assessment needs to be analyzed and the applicant should check back to find out the results of the assessment. On the other hand, if the online assessment was immediately scored, a new message informing the applicant of the results of the online assessment is placed in the message block on the applicant home page 202. In some situations, the results of the online assessment will indicate that the applicant is not a proper fit for the position and the applicant will be informed of this decision. In other situations, the results of the online assessment will indicate that the applicant is questionable for the position and the applicant will be asked to return to the home page in a week to find out whether the company wishes to interview the applicant. In a desired scenario, the results of the online assessment will indicate that the applicant is a good match for the position, and the automatically generated message will inform the applicant that the company would like to conduct a telephone interview with the applicant.

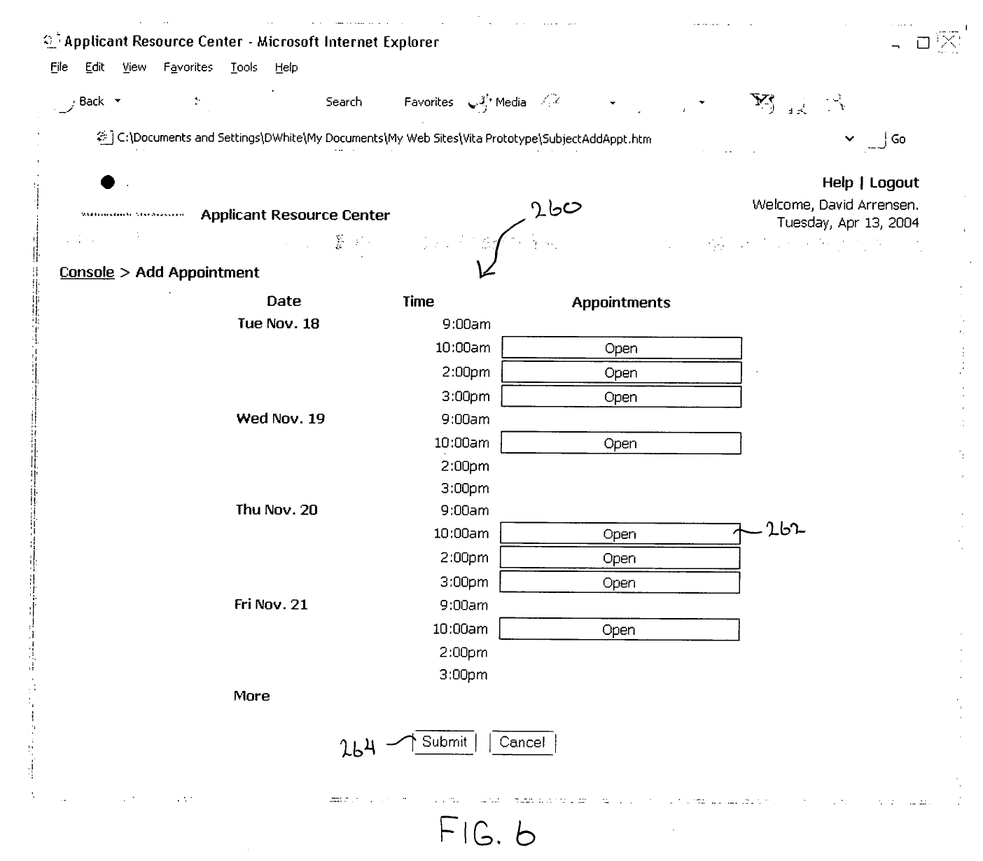

If the applicant is provided a message requesting a telephone interview, the applicant is provided a link to a scheduler page 260, such as that shown in FIG. 6. The scheduler page 260 provides the applicant with a list of potential times for the telephone interview, and the applicant is asked to select one of the times. In particular, the scheduler page 260 lists various times on numerous days and indicates that a time is open for an appointment with the interviewers if an “open” box 262 is shown next to that time. The applicant selects one of the times by simply clicking on the appropriate “open” box 262 with his or her mouse and then clicking the “submit” button 264. When a telephone interview is booked by an applicant, the central computer 101 books this same time for the interviewers and notes that a telephone interview with the applicant is scheduled. At the same time, the system 100 also sends a message to the interviewer workspaces 500 to alert the interviewers that a telephone interview has been scheduled.

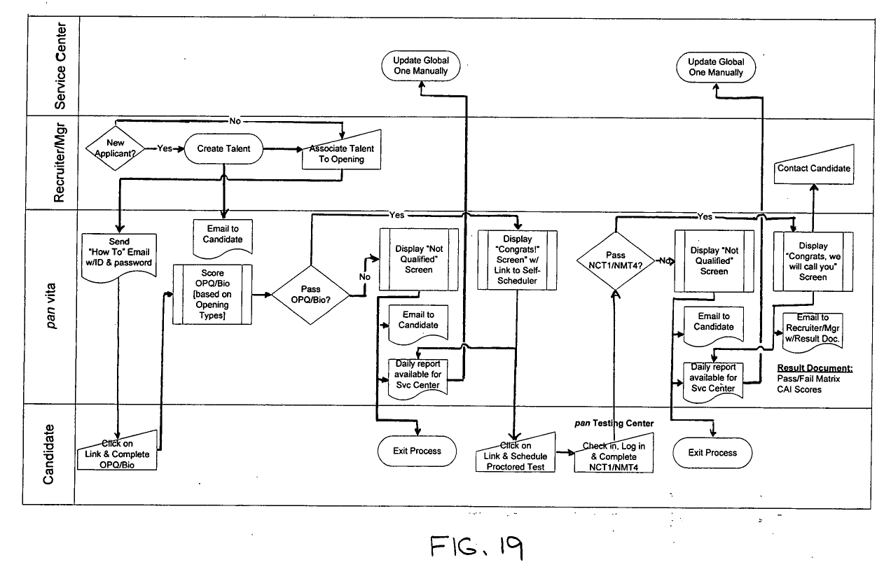

With reference to FIG. 19, a process flow chart is provided showing the interaction between the central computer 101 and a user in the applicant environment for the stages of the hiring process 99 through the phone screen stage 126, as described above.

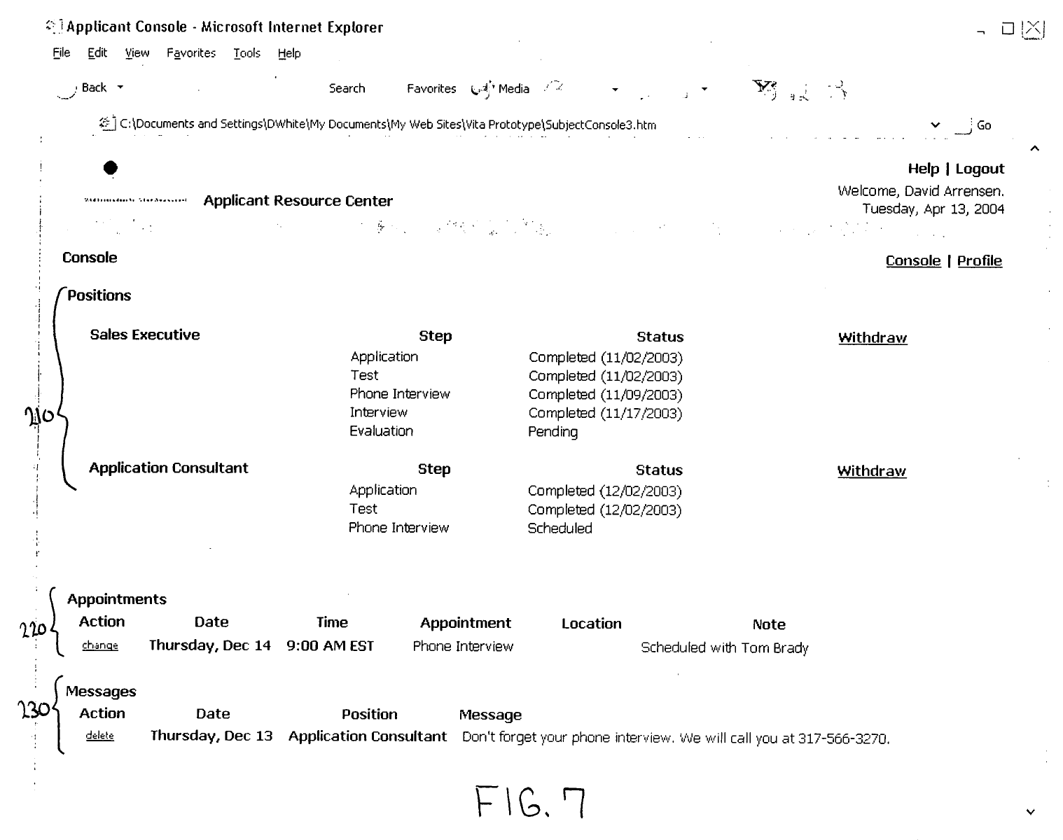

FIG. 7 shows an exemplary applicant home page 202 for applicant David Arrensen after applying for the application consultant position. FIG. 3 previously showed an exemplary home page for this applicant before applying for this position. In FIG. 7, the current status block 210 shows that the applicant has applied for the position of “sales executive” as well as “application consultant.” With respect to the “sales executive” position, the applicant is awaiting evaluation of an interview session. With respect to the “application consultant” position, the applicant has completed the application, an online test, and is scheduled for a phone interview. Accordingly, the appointments block 220 now notes that a phone interview is scheduled with an interviewer at 9 AM on Dec. 14. In the messages block 230, the message stating that the applicant is a match for the “application consultant” position has been removed and a new message is posted with instructions regarding the upcoming phone interview for the “application consultant” position.

FIGS. 3-7 provide a simple example of the functionality of the system through a workspace 150 in the applicant environment 200. The information provided to the applicant through the applicant workspace 150 provides for improved communication between the applicant and the organization in the job application process. Furthermore, although FIG. 2B only shows two applicant workspaces using the system, numerous applicant workspaces are anticipated. Each applicant workspace will generally have the same look and feel, but the information available to each applicant under his or her personal applicant workspace will be individualized based upon the applicant's status. In addition, the applicants using the system 100 may be individuals seeking employment with the organization as well as current employees seeking new positions within the organization.

The Hiring Manager Environment

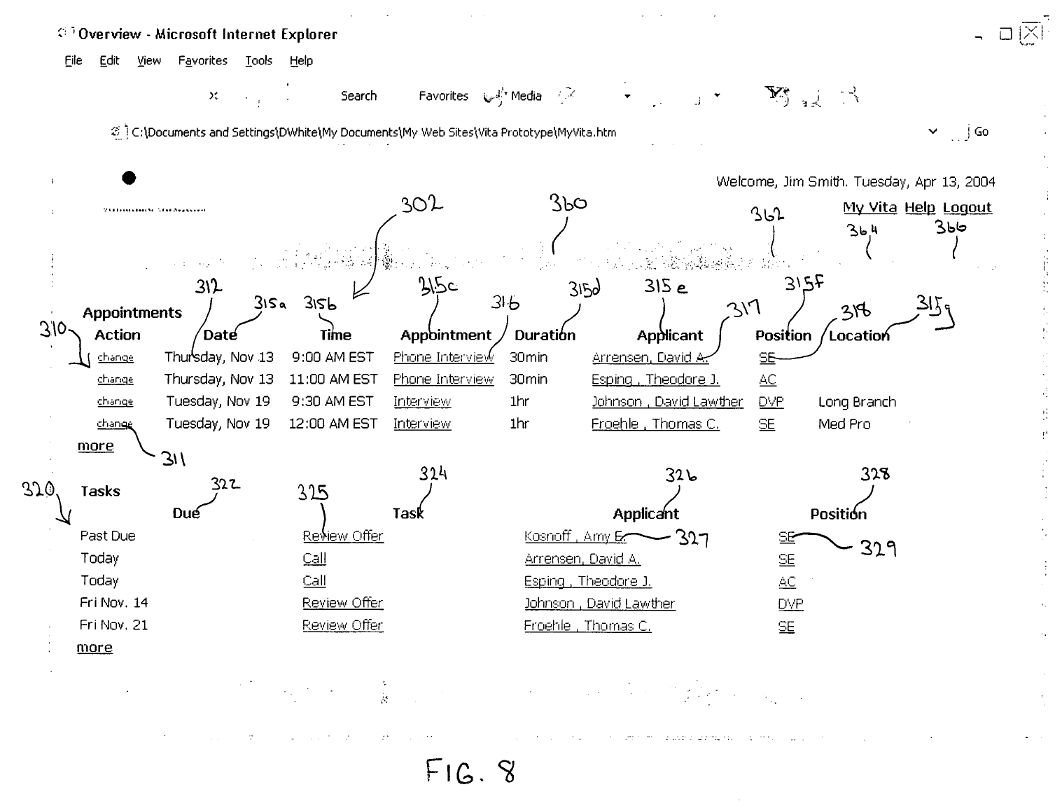

FIGS. 8-11 show several exemplary pages of an exemplary hiring manager workspace 152 in the hiring manager environment 300. The hiring manager workspaces are but one type of several types of user workspaces available through the system 100, as noted in FIG. 2B. Depending on the organization, there may be a single hiring manager or several hiring managers responsible for hiring different types of employees. Accordingly, there may be a single or a plurality of hiring manager workspaces. The hiring manager workspaces in the hiring manager environment 300 all have a similar look and feel, but the data provided through each hiring manager workspace will be unique to the individual hiring manager. The exemplary hiring manager workspace of FIGS. 8-11 provides hiring information unique to exemplary hiring manager Jim Smith.

With reference to FIG. 8, an exemplary hiring manager home page 302 is shown. The hiring manager overview page 302 includes an appointments block 310 and a tasks block 320. The appointments block 310 lists all upcoming appointments for the hiring manager scheduled by the system. Each appointment listed includes the date and time of the appointment under a “Date” heading 315a and a “Time” heading 315b, the type of appointment under an “Appointment” heading 315c, the duration of the appointment under a “Duration” heading 315d, the applicant's name under an “Applicant” heading 315e, the position applied for under a “Position” heading 315f, and the location of the opening under a “Location” heading 315g. For example, the first appointment 312 listed in the appointments block 310 shows that the hiring manager has a 30 minute phone interview scheduled for Nov. 13 at 9 am with applicant David Arrensen for the sales executive position.

Each appointment listed in the appointments block 310 is automatically created by the system based upon the electronic calendars of the appointment participants. To this end, the system includes a scheduler program held by the central computer 101. The scheduler is operable to automatically schedule appointments for job applicants and interviewers. For example, if a job applicant is slated for a telephone interview, the scheduler will compare the times the applicant noted as being available for a phone interview with the electronic calendars of the interviewers and automatically schedule the telephone interview using a time that is open for all parties. To this end, the scheduler may be programmed to schedule different types of appointments in different fashions. For example, the scheduler may require a phone interview to be conducted by the hiring manager and at least one other interviewer selected from a pool of possible interviewers. The scheduler will then select a time for the interview that is available to both the hiring manager and at least one other interviewer. Once the time for the interview is selected, the scheduler lists the interview in the appointments block 310 for both the hiring manager and the other selected interviewer, and a new message appears in the message block of the applicant's home page informing the applicant of the new interview time. If the hiring manager is not available during any of the times noted by the applicant, the scheduler will place a message on the home page 202 of the applicant's workspace, asking the applicant to select several new times for a possible phone interview. Once the applicant has selected new times, the scheduler once again attempts to schedule the interview. Also, if the hiring manager or other interviewer ever needs to re-schedule an appointment, an appointment change link 311 is provided to the left of each listed appointment. By clicking this link 311, the interviewer can indicate that an appointment can not be met and can request that the scheduler set up a new appointment.

Numerous other rules may be programmed to guide the scheduler in setting up appointments. For example, the scheduler may be programmed such that no appointments may be scheduled within two business days from the time the scheduler attempts to make an appointment. This prevents unexpected appointments from appearing on the calendars of the hiring manager and other interviewers without advance warning. As another example, different pools of interviewers and numbers of interviewers may be selected by the scheduler depending upon different job positions and job locations.

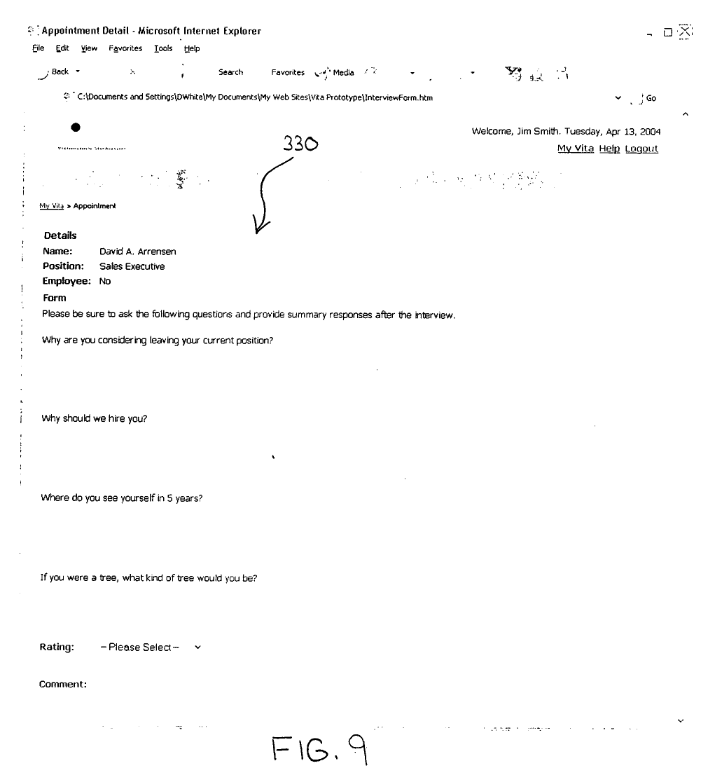

In addition to providing the hiring manager with an overview of upcoming appointments, the appointments block 310 provides several links to valuable additional information about each of the upcoming appointments. In particular, for each appointment listed, the hiring manager is provided with a link to information about the goal of the appointment, information about the applicant, and information about the position the applicant has applied for. For example, if the hiring manager clicks on the link 316 under the “Appointment” heading 315c for the upcoming phone interview with David Arrensen, a page is displayed showing the hiring manager certain questions to ask during the phone interview. FIG. 9 shows an exemplary interview page 330 that appears if link 316 is selected. As shown in FIG. 9, the interview page 330 provides the hiring manager with a list of questions to be asked during the upcoming phone interview. This page 330 is used by the hiring manager during the phone interview to provide structure to the phone interview and make sure the hiring manager obtains answers to certain questions deemed relevant by the HR department. This page is generally used to focus each interviewer on a particular area of evaluation, and encourages the interviewers to ask related questions. Of course the hiring manager is free to ask additional questions during the phone interview, as the hiring manager deems appropriate. At the bottom of the interview page 330, the hiring manager is asked to rate the applicant and provide additional comments. This rating and additional comments may be used by the hiring manager and HR to make decisions on whether the applicant should be passed on to the next stage of the application process. Use of the interview page 330 provides each interviewer with convenient and easy access to information to guide the interviewer through the interviewing process, as well as a convenient way to respond in order to evaluate each candidate immediately after the interview. With structured interview sessions provided with the interview page 330, the entire interview process is generally more informative for HR and those making hiring decisions than it would be if each interviewer is left to his or her own discretion when conducting interviews.

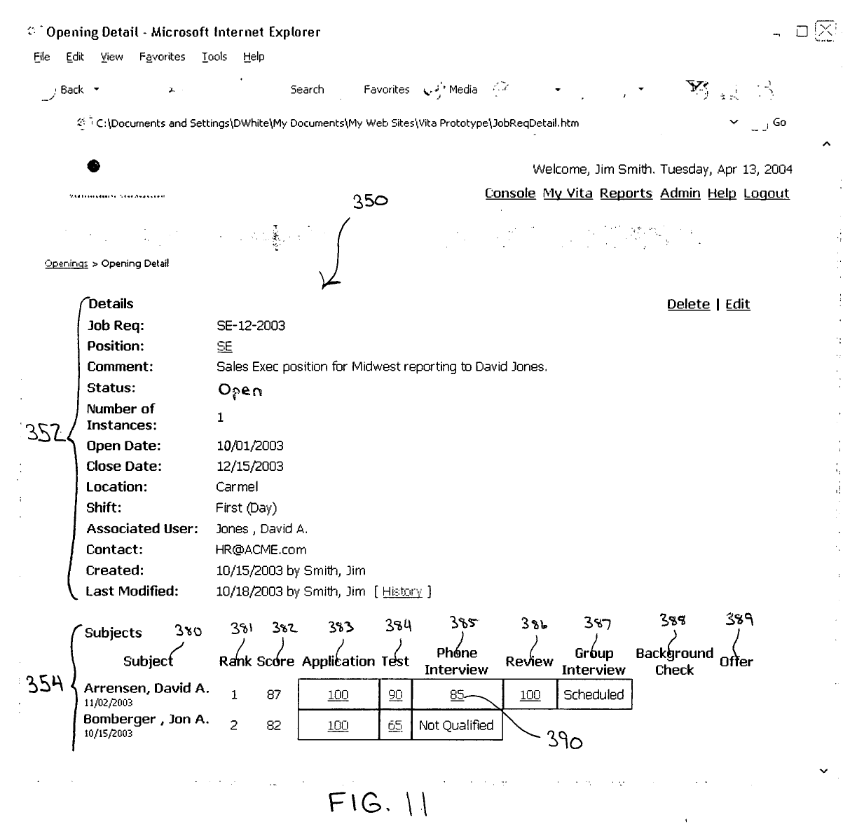

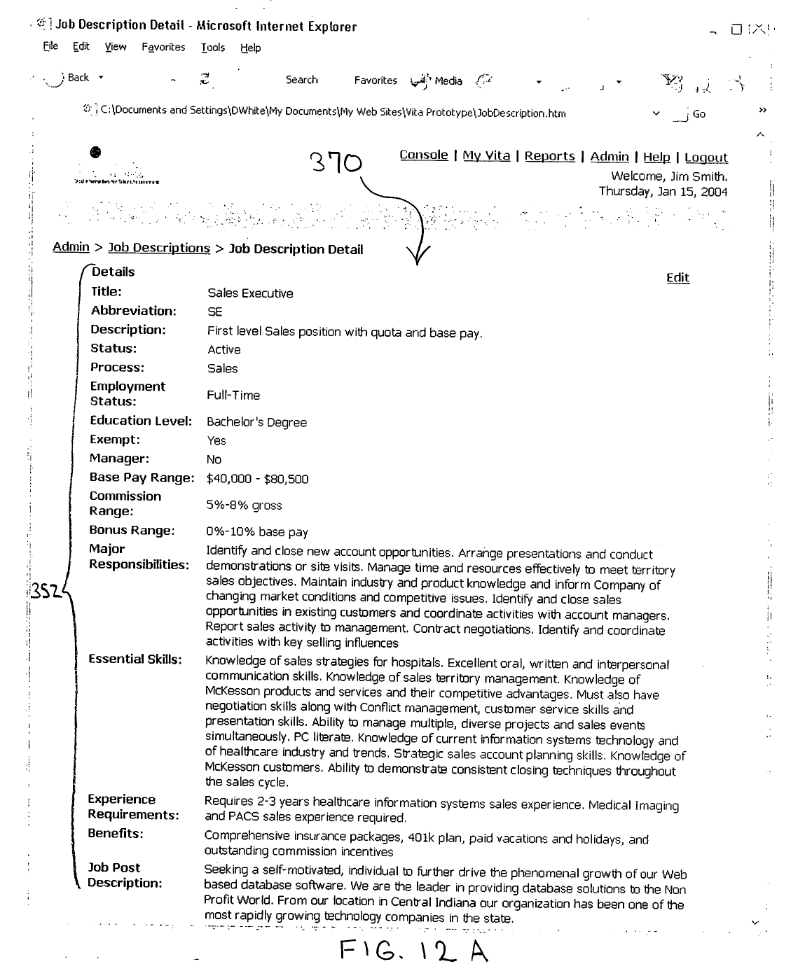

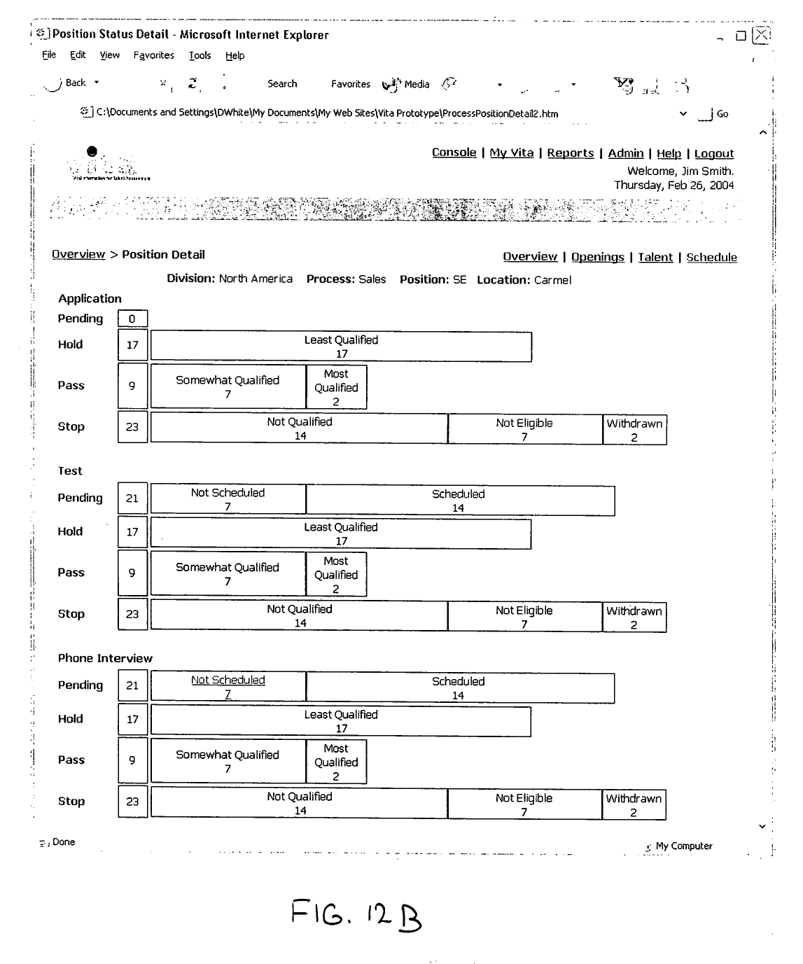

With reference again to FIG. 8, each appointment listing 312 also includes a link to detailed information about the applicant 317 and a link to additional information about the job position 318. If the applicant link 317 is chosen, a page appears showing personal information about the applicant. This personal information includes the information the applicant entered about himself or herself when the applicant completed the online resume through the system. Of course, this personal information can be very valuable to the hiring manager when asking questions during an interview. For example, the hiring manager may be interested in finding out more information about past job experiences of the applicant and these past experiences are listed for the hiring manager when the applicant link 317 is clicked. If the job position link 318 is chosen, a page is displayed showing detailed information about the open job position. An exemplary job description page 350 is shown in FIG. 11 and is discussed in further detail below. A second exemplary job description page 370 is shown in FIG. 12A, and includes more detailed information concerning the job opening, which may be of assistance to the hiring manager during an interview. Either or both of these job pages may be available to the hiring manager by clicking on the job position link 318.

In addition to specific information about a job opening, an overview of all candidates that have applied for a particular job is also available through the hiring manager workspace. For example, the information provided in FIG. 12B may be available at the bottom of one of the job description pages, such as at the bottom of FIG. 12A, or may be accessible through a direct link on such page or another page. The information provided in FIG. 12B shows a breakdown of the total number of candidates that are slotted in each of various stages of the hiring process. This analysis lists the total number of candidates in a “hold” position, “pass” position or “stop” position for each hiring stage. In addition, a bar chart categorizes the candidates according to their qualification level. This information may be used by the hiring manager to obtain an indication of how many candidates are progressing through the hiring process along with the general qualification level of such candidates.

With reference again to FIG. 8, a list of tasks to be completed by the hiring manager is included in the tasks block 320 of the hiring manager overview page 302. The task list includes a short description of each task under a “Task” heading 324, a due date for each task under a “Due” heading 322, the applicant to whom the task relates under an “Applicant” heading 326, and the position to which the task relates under a “Position” heading 328. Each task listed in the task list includes a plurality of links to other pages. For example, with respect to the first task on the list, the hiring manager may click on link 325 to find out more information about the task “Review Offer”. The information provided will help the hiring manager determine exactly what needs to be done and will provide the hiring manager with any additional information required to complete the task. In this case the offer to be reviewed can be seen by the hiring manager by clicking on the “Review Offer” link 325. Similar to the links provided in the appointments block 310, the tasks block 320 also includes an applicant link 327 and a position link 329 for each task in the list.

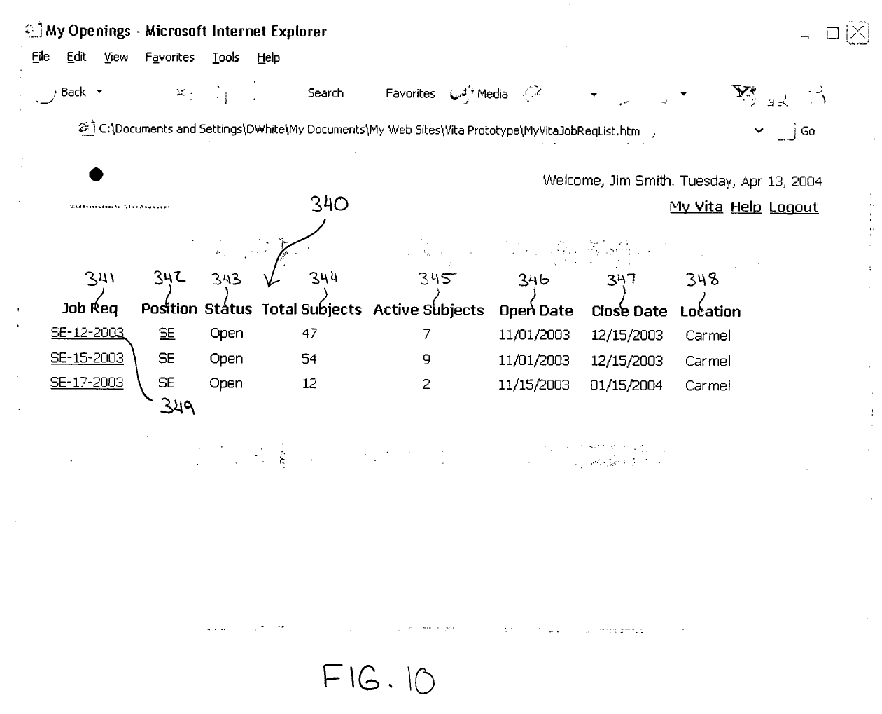

With continued reference to FIG. 8, a banner 360 is provided across the top of the hiring manager overview page 302. On the right side of the banner, the hiring manager is provided with an overview option 362, an availability option 364, and an openings option 366. The overview page 302 of FIG. 8 is what is shown when the hiring manager clicks on the overview option 362. When the hiring manager clicks on the availability option 364, the hiring manager is taken to his or her electronic calendar and can block off periods of time where he or she will be unavailable to participate in any interviewing activities. Accordingly, the scheduler will not schedule the hiring manager for any interviewing activities during these unavailable times. When the hiring manager clicks on the openings option 366, he or she is taken to an openings page 340, such as that shown in FIG. 10.

FIG. 10 shows an exemplary openings page 340 listing all openings for which the hiring manager is responsible. As shown in FIG. 10, the hiring manager is currently responsible for filling three open jobs, all for the “SE” (sales executive) position. Each listing on the openings page 340 includes the job code under a “Job Req” heading 341, and a job description under a “Position” heading 342. In addition, each listing includes an indication of whether the job has been filled or remains open under a “Status” heading 343, the total number of applicants that have applied for the job under the “Total Subjects” heading 344, and the total number of applicants that remain active and potentially qualify for the job under the “Active Subjects” heading 345. Finally, each listing includes the date the job listing opened under a “Open Date” heading 346, the date each job listing will close under a “Close Date” heading 347, and the location of the job opening under the “Location” heading. This openings page 340 provides the hiring manager with a quick summary of each job for which he or she is responsible. If additional information about any of the listed jobs is desired, the hiring manager may click on the one of the Job Requisition links 349 to view a job description page 350, as shown in FIG. 11, showing additional information about the listed job.

With reference to FIG. 11, the job description page 350 provides detailed information about the job opening in a details block 352. In addition to the information shown in the details block 352 of FIG. 11, the details block may also include the additional information included in the details block 352 of FIG. 12, or other relevant information. This additional information may include, for example, education requirements, compensation, and job responsibilities.

Returning to FIG. 11, the job description page 350 also includes a subjects block 354. The subjects block 354 lists each of the job applicants for the particular job under a “Subject” heading 380, ranks the applicants under a “Rank” heading 381, and provides a current total system score for each applicant under a “Score” heading 382. In addition, the subjects block 354 provides information on each applicant's progress from application to offer. If a particular step is completed, the subjects block 354 will note completion with a score or other status indicator, such as “pass” or “fail”, to show that the step is completed and the results of the step. If a step is only scheduled to take place, but not yet completed, the subjects block 354 will note that the step is “scheduled.” If a step has not been completed, nothing will be shown for that step in the subjects block 354.

The applicant's score from the questions asked as part of the online application is listed under an “Application” heading 383; the applicant's online test score is listed under the “Test” heading 384; the applicant's phone interview score is listed under a “Phone Interview” heading 385; the applicant's HR review score is listed under a “Review” heading 386; the applicant's group interview score from the in-house interviews is listed under the “Group Interview” heading 387; the applicant's pass or fail status from the background check is listed under the “Background Check” heading 388; and the status of an offer to the applicant is listed under the “Offer” heading 389. For certain stages, a “score” for a particular stage may assigned based upon a pass/fail status for that stage. For example, following an application stage, an applicant may be assigned a “pass” or a “fail” status. If the applicant passes, he or she is awarded a score for that stage of 100. If the applicant fails, the applicant is not passed on to additional stages.

In the example shown in FIG. 11, applicant David Arrensen is currently the top ranked candidate for the SE position to fill job SE-12-2003. Mr. Arrensen's current score, as computed by the system is an 87. This score that determines a candidates rank is based on an algorithm decided by each organization and for each job. This score is typically a function of the scores compiled for different steps of the application progress, with different weights given to different steps of the process. For example, HR may determine that for a particular job, heavy weight for the applicant's score will be placed on the online screening test. An “average” weighted score is then calculated for all steps completed by the applicant, with the score from the online screening test given the most weight. For other jobs, heavy weight may be given to the interview scores with less weight to scores for other steps in the process. Furthermore, when calculating the “Group Interview” score, the score one interviewer (e.g., the hiring manager) gave the applicant may be given greater weight than the score another interviewer gave the applicant. By allowing for a weighted average score in this manner, the system is operable to allow organizations to place different emphasis on different steps for different jobs as an applicant progresses from job application to job offer. The system is also operable to rank these candidates based on their performance during different steps of the hiring process 100.

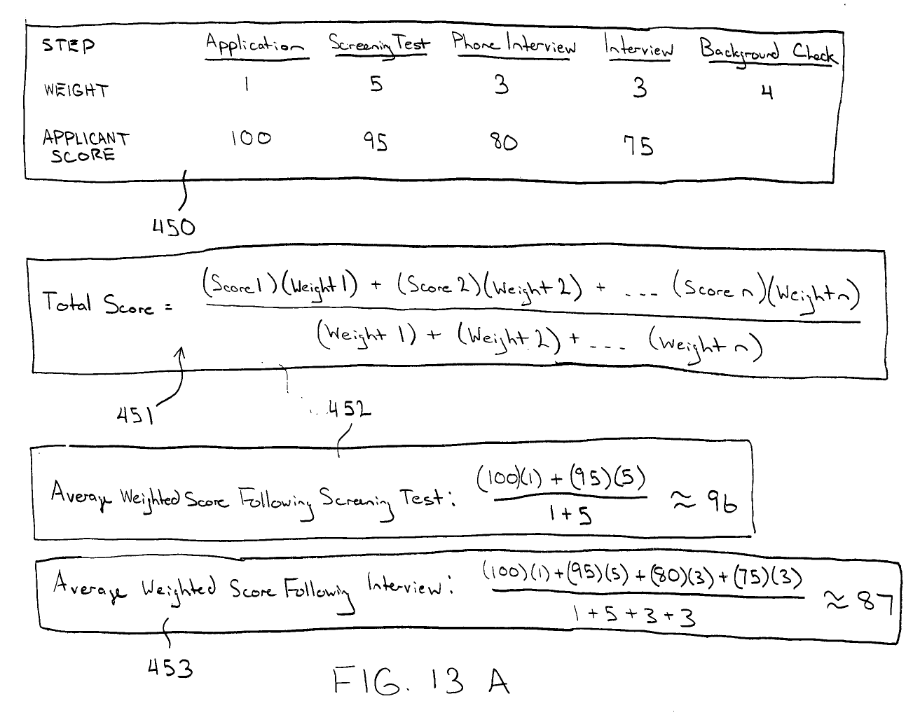

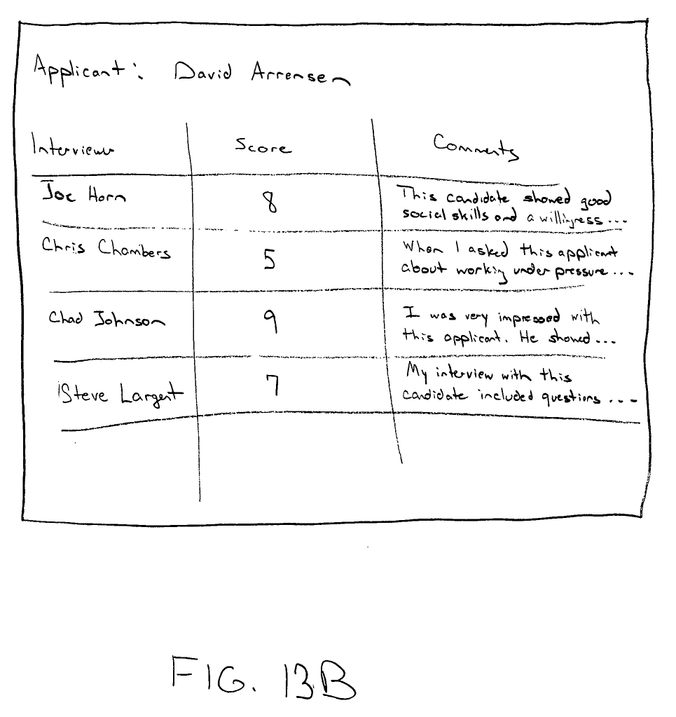

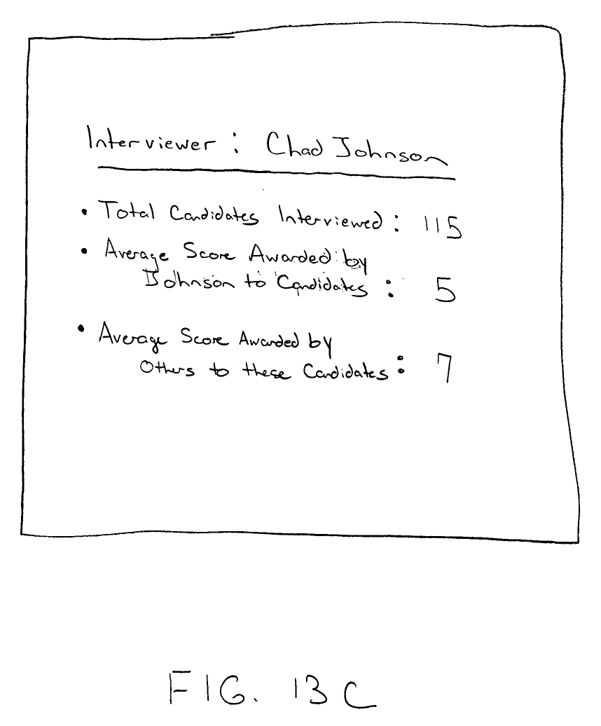

An example of calculation of an average weighted score is shown in FIG. 13A. FIG. 13A lists in block 450 various steps of a hiring process and an exemplary applicant's score for each step of the process. A formula 451 for determining the average weighted score of the applicant for the job opening is also shown. As shown in block 452, following the screening test stage, the applicant's average weighted score is 96. As shown in block 453, following the interview stage, the applicant's average weighted score is 87. As mentioned above, after the applicant's total score is calculated, the system ranks the applicants such that the highest applicants are viewed first.

The ranking system described above provides the hiring manager with a convenient method of quickly viewing the top candidates for a particular job through the use of a weighed average score for each candidate. When the hiring manager views the list of job candidates in the subjects block 354 of the job description page 350 of FIG. 11, he or she can find out more information about the applicant's performance during each step of the hiring process 100. In particular, each score or other status indicator under the headings 383-389 provides a link to more detailed information about that score or status indicator. For example, if the hiring manager wishes to see the comments from the phone interview with applicant David Arrensen, link 390 is clicked. When link 390 is clicked, a new page appears showing details of the phone interview with David Arrensen, including the interviewer comments and rankings. Accordingly, the hiring manager is provided with information about each candidate during each step of the hiring process when making a job decision. This information can be very helpful to the hiring manager when making a job decision that must distinguish between two or more finalists to fill a job opening.

In one alternative embodiment of the system, only candidates that have passed a certain stage of the hiring process are ranked. For example, by ranking only those candidates that have passed the online screening stage, the system avoids awarding an inflated rank to candidates that received a relatively high score in an early stage (e.g., the application stage). Since relatively little is still known about these candidates, further evaluation and testing is required before such candidates are included in the ranking mix.

In another alternative embodiment of the invention, the hiring manager is provided with additional information about the interviewers that ranked particular candidates. For example, referring again to FIG. 11, assume the hiring manager is deciding between two finalists for a particular job opening, and notices that one of the candidates scored lower than the other candidate on the group interview score. If the hiring manager clicks on the link associated with the score for such candidate under the group interview heading 387, the hiring manager will be provided with additional details about the candidate, including comments from each interviewer and a score from each interviewer, such as that shown in FIG. 13B. The hiring manager will be experienced enough to know that certain interviewers rank candidates more harshly than other interviewers. Thus, the hiring manager will recognize that a rank of “7” from one interviewer is relatively high for that interviewer, while a rank of “7” from a different interviewer is relatively low for that interviewer. By clicking on the interviewer name, the hiring manager can obtain additional information about the interviewer. In particular, by clicking on the interviewer name, the hiring manager can find the average score the interviewer has assigned to all candidates as well as the total number of candidates ranked by the interviewer. The hiring manager may also be provided an average score awarded by others to the same set of candidates. An example of such a page is shown in FIG. 13C. This information may be of great assistance to the hiring manager when making final hiring decisions. In the example provided, FIG. 13C shows that interviewer Chad Johnson has awarded an average score of 5 to more than one hundred candidates interviewed, while the average score from other interviewers for this same set of candidates was 7. FIG. 13B shows that Johnson has awarded candidate David Arrensen a score of 9. This indicates to the hiring manager that this particularly difficult interviewer was very impressed with the candidate since he was awarded a relatively high score for the interviewer. On the other hand, if interviewer Joe Horn has awarded an average score of 8 to more than fifty candidates interviewed with an average score from others of 7, and has awarded David Arrensen a score of 8, this will indicate to the hiring manager that this relatively easy interviewer was not particularly impressed with the candidate. In total, this information and all of the other information available to the hiring manager through the system 100 will help the interviewer make important decisions with respect to new hires for the organization.

The Interviewer Environment

Referring again to FIG. 3, each workspace in the interviewer environment 400 is similar to the above-described hiring manager workspace 152 with information individualized for each employee participating in the interview process as an interviewer. Furthermore, the individual interviewer workspaces 154, 155 may be more or less restrictive in terms of the data the employee can view through the workspace. The level of restriction is typically dependent upon the clearance level of the employee. For example, the vice-president of the company may only occasionally interview an applicant, and may use the system only sparingly, but may be granted unlimited access to the information in the system. On the other hand a relatively new engineer may be asked to occasionally interview an engineering candidate, but will only be granted access to very limited information. Accordingly, all information and/or pages available through the system may be granted a defined clearance level along with the individual users of the system, and the system will only allow individual users to view information if the clearance level of the information is less than or equal to the clearance level of the individual.

The HR Environment

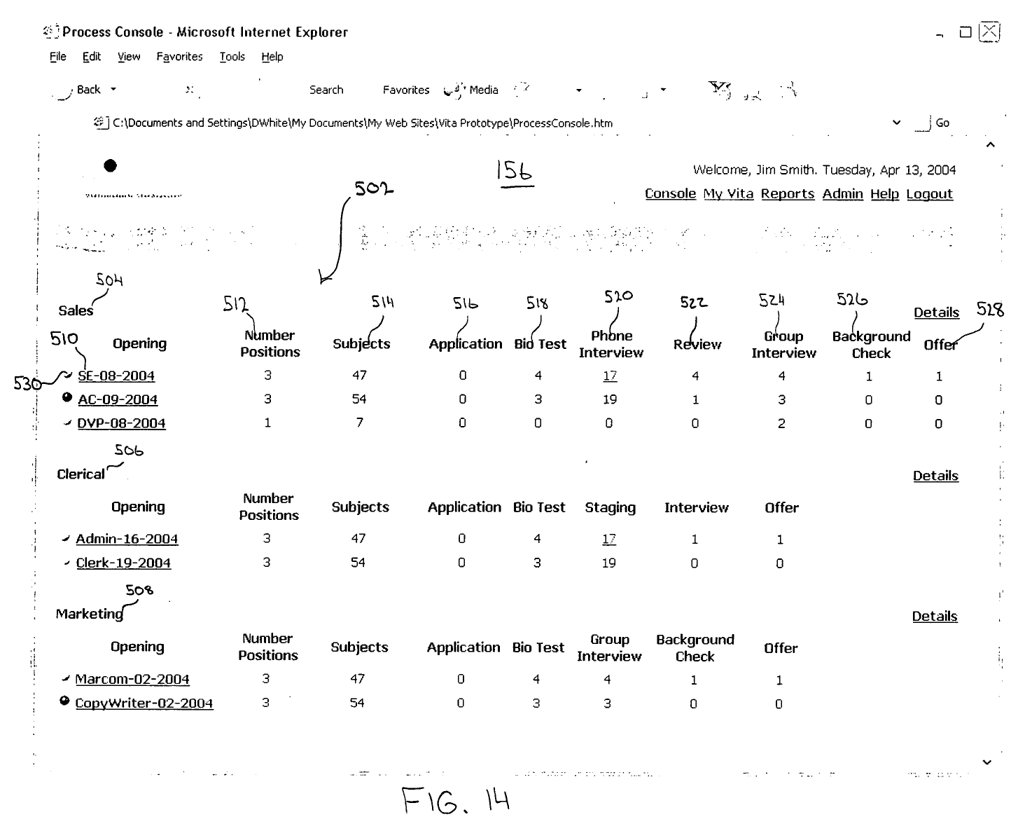

Turning to FIGS. 14-16, several pages of an exemplary HR workspace 156 in the HR environment 500 are shown. Workspaces in the HR environment 500 typically provide an overview of all job openings and all candidates in the system. However, even in the HR environment, information may be restricted depending upon the clearance level of the user. Furthermore, although not specifically displayed in the figures, users of the system in the HR environment will each have access to a list of appointments and tasks scheduled by the system for such user. Thus, the general arrangement from other workspaces, such as that shown in FIG. 8 for the hiring manager environment, may be used to provide appointment and task information to those in the HR environment.

Turning now to FIG. 14, an exemplary job openings page 502 is shown in an exemplary HR workspace. The job openings page 502 generally lists all job openings within the organization. The job openings listed on the page 502 are organized under a number of job classification headings, including a “sales” heading 504, a “clerical” heading 506, and a “marketing” heading 508. Of course, any number of different job classifications and associated headings may be created using the system, depending upon the jobs available through the organization. Specific jobs on the job openings page 502 are identified by a job code 510 associated with the job. For each job listed, one or more positions are available. Alternatively, each job listed is representative of a single position, and a unique code is associated with that single position. In any event, next to each job listed on the job openings page 502 is information about the organization's progress towards filling that position or positions. In particular, the number of positions for that job is listed under a “number positions” heading 512. The total number of candidates that have applied for the job is listed under the “subjects” heading 514. The number of candidates that currently reside at different stages of the hiring process are listed under headings 516-528. For example, in FIG. 14, seventeen applicants are scheduled for phone interviews, as noted under heading 520, and one candidate has been given an offer, as noted under heading 528. In this manner, the HR openings page provides a concise overview of the organization's progress toward filling job openings with qualified workers.

To the left of each job code 510 on the HR openings page is a colored circle 530 or “status light”. Each status light 530 is green, yellow or red in color. Green may indicate that the open position (or positions) for that job is likely to be filled by the deadline for filling such open position. A yellow circle may indicate that the deadline for filling the open position is approaching, and based upon the information available about the candidates that have applied for the job, care should be taken to ensure that the position is filled by the deadline. A red circle may indicate that a deadline for filling an open position is very near, and based upon the information available about the candidates that have applied for the job, there is a significant danger that a job opening will not be filled by its deadline. Thus, when a red circle appears next to a job, HR is notified to take immediate action to quickly process the existing candidates through the system and/or find additional applicants to process through the system on an expedited basis. In this manner, the job openings page 502 provides a probability indicator suggesting whether a particular position will be filled by the deadline to fill the position, and urges additional action when appropriate. Additional detail concerning the job fill probability indicator is provided below under the heading “Best Candidate Probability Indicator”.

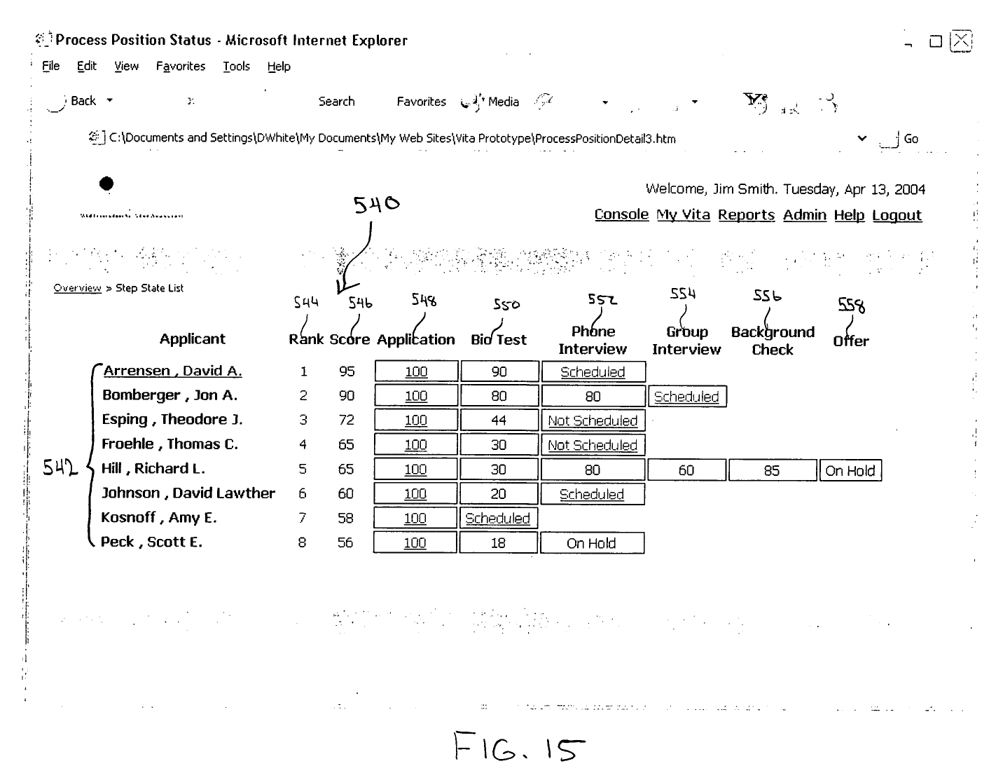

If the user of the HR openings page 502 would like additional information about the candidates that have applied for particular job, he or she simply clicks on the job code 510 associated with that job, and a ranked candidate page 540 appears, such as that shown in FIG. 15. The ranked candidate page 540 includes a list 542 of all candidates that have applied for the position. The candidates are listed in order of rank based upon an overall score awarded the candidate by the system. Each candidate's rank compared to the other candidates is provided next to the candidate name under a “rank” heading 544. The overall score awarded the candidate by the system is listed next to the rank. As discussed previously, the overall score awarded the candidate is based upon a weighted average of all the candidate scores from different stages of the hiring process. Individual scores for each stage the candidate has completed are listed under the corresponding heading 548-558 for that stage. If more information is desired about a particular score, the user simply clicks on the score, and a new page is provided that explains the score in further detail. For example, if a particular applicant scored well on an online test, but did not score well on a phone interview, clicking on the score for the phone interview will reveal the rationale for the poor phone interview score. With this information, the HR department is equipped to quickly obtain detailed information about applicants for a particular job and the progress of such applicants through the hiring process. If the HR department observes that a particular candidate otherwise seems well equipped for a particular job, but scored low in one stage of the hiring process, information about the low score may be obtained and HR may determine whether the low scored may be explained or whether further evaluation should be conducted for the candidate.

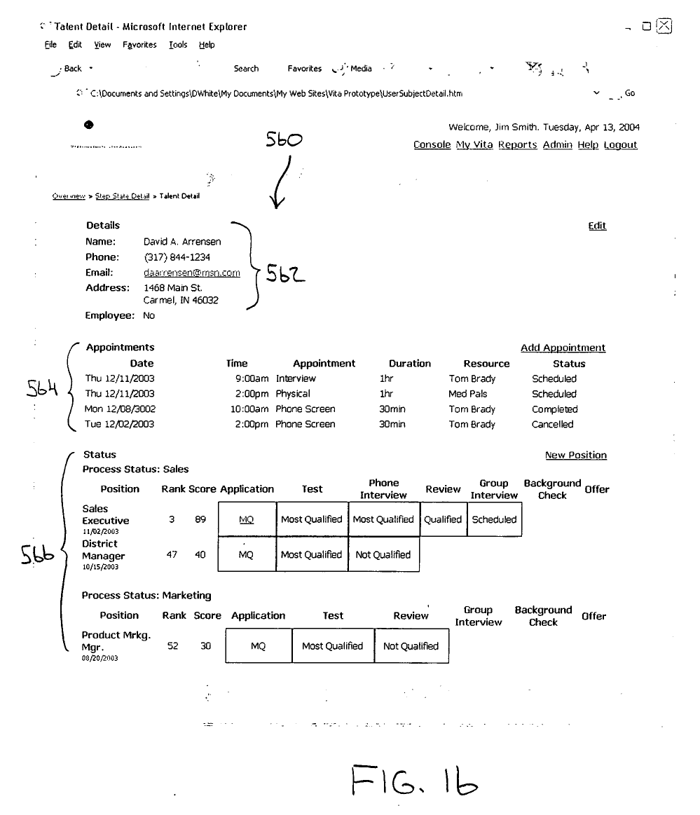

On occasion, HR may wish to learn more information about a particular job applicant with respect to all jobs within the system. If such information is desired, the user in the HR environment may click on the applicant's name from the applicant list 542 on the ranked candidate page of FIG. 15. When an applicant's name is clicked, an applicant detail page 560 is provided, such as that shown in FIG. 16. The applicant detail page 560 generally provides an overview of all information in the system related to the applicant. In particular, the applicant detail page 560 provides contact information 562 for the applicant, upcoming appointment information 562 for the applicant, and hiring process status information 566 for all jobs applied for by the applicant. The status information 566 includes the applicant's rank relative to other applicants for each job, as well as the applicant's overall score, and individual scores for each stage of the hiring process.

Altogether, pages in the HR environment provide the organization's HR department with up-to-date information about each applicant within the system, each job within the system, and indicators to suggest whether additional work is needed to fill certain jobs within the system. With these tools, the HR department is in position to orchestrate the hiring process and ensure that decisions to hire are made at the proper time, that the best available candidates are hired for each open job, and that highly qualified candidates are not lost in the system.

Best Candidate Probability Indicator (Pipeline Barometer™)

As described above, the status lights 530 on the HR openings page 502 of FIG. 14 provide a best candidate probability indicator. The status lights 530 are generally one of three colors. Green indicates no warning, as the process is generally proceeding as expected. Yellow indicates a moderate warning. Red indicates a serious warning. The status light warnings generally apply to three different potential problems for any given job opening. First, the status lights 530 provide a warning if the probability of finding a qualified candidate is low based upon the total number of applicants for the job. Second, the status lights 530 provide a warning if the deadline for filling the job opening will likely pass before a qualified candidate reaches the offer stage. Third, the status lights 530 provide a warning if there are highly ranked candidates for a particular job that are likely to be missed if they are not fast-tracked through the hiring process before the deadline. As explained in further detail below, each status light warning is based on statistical information maintained by the system about the job opening. This statistical information includes, for example, the total number of job applicants, the rank of each job applicant, the probability for passing through the hiring process, and the typical time to pass through the hiring process.

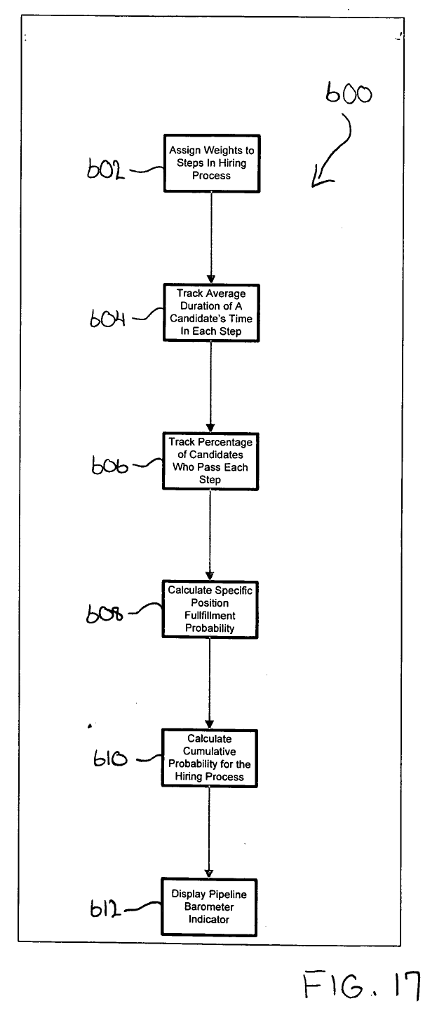

FIG. 17 shows a block diagram of the steps 600 taken by the system when determining appropriate warnings for the best candidate probability indicator. First, in step 602, a weight is assigned to each stage of the hiring process for each different job classification. This weight may be the same as that assigned to each stage for the purpose of determining an average weighted score and ranking the candidates, as described above with respect to FIG. 13A.

Second, in step 604, the system tracks the average duration of a candidate's time to pass through each stage of the hiring process for such job. For example, if a typical time to pass from the online test stage to the phone interview stage for a particular type of job is seven days, this data is calculated and saved by the central computer. Since new candidates are often in the system passing from stage to stage, this data must also be periodically recalculated and updated. However, over time, it is expected that this average duration will settle into a stable number for each different job type. Of course, when an organization first begins to use the system, anticipated values for average duration of time to pass through a stage will need to be used until an acceptable data set is compiled that will allow the system to keep an ongoing record of the time duration.

Third, in step 606, the system tracks the percentage of candidates who pass each stage of the hiring process and move on to the next stage. For example, based on the data compiled by the system, it may be determined that only 40% of the candidates that take the online screening test pass the test and move on to the phone interview stage. Again, this data must be periodically recalculated and updated as each applicant moves through the system. However, it is expected that this percentage of candidates passing each stage will settle into a stable number for each different job type. Also, when the organization first begins to use the system, anticipated values for the percentage of candidates to pass through a stage will need to be used until an acceptable data set is compiled that will allow the system to keep an ongoing record of this percentage.

Following this, in step 608, the system calculates a specific position fulfillment probability. This position fulfillment probability provides a probability for each stage of the process that the candidate will pass the remaining stages of the process and receive and accept an offer. To calculate this probability, the percentage calculated in step 606 for such stage is multiplied together with the remaining percentages in the hiring process from step 606 to arrive at a cumulative probability specific position fulfillment probability. The resulting number for each stage is the probability that any one candidate will receive and accept an offer from such stage. The resulting number for the first stage of the hiring process is the total cumulative probability for the entire hiring process, as noted in step 610.

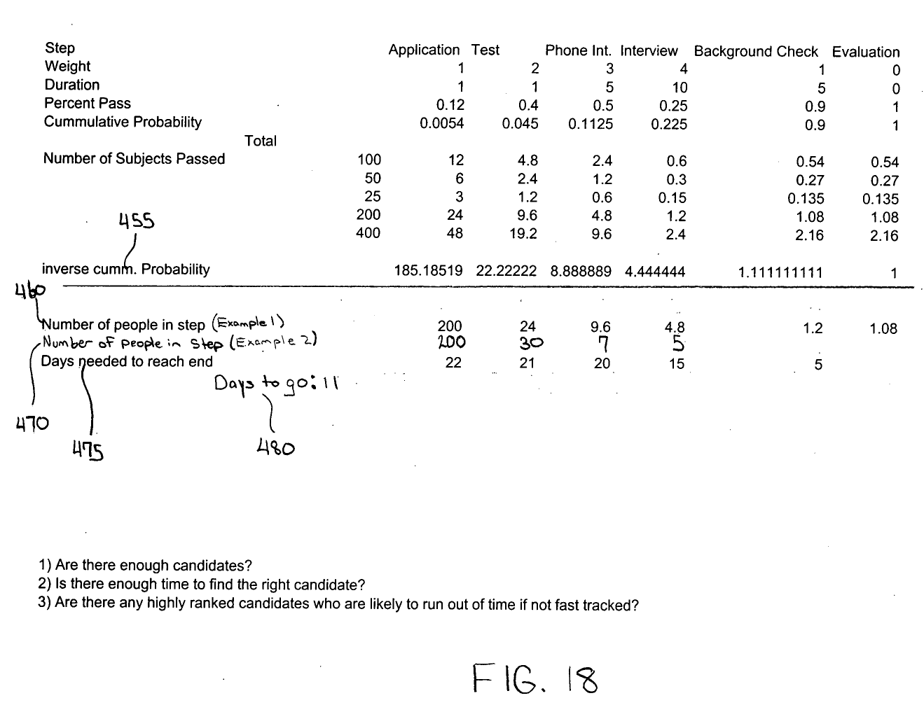

An example of this hiring process probability calculation is shown in FIG. 18. FIG. 18 lists the steps of a hiring process, the weight given to each step, the typical duration a candidate spends in each step (in number of days), the percentage of candidates that traditionally pass each step and the cumulative probability that a candidate will proceed to the offer stage and/or accept the offer. As mentioned above, the cumulative probability amount for any given stage is calculated by multiplying the percent pass amount for such stage by the percent pass amounts for each of the remaining stages in the hiring process. In the example provided, there is a 0.54% chance that a given applicant in the application stage will be passed to the end of the hiring process and receive an offer. Accordingly, the inverse of this number provides an indication of the total number of applicants that are likely required in order to have an acceptable applicant for the job opening. In this case, as shown in the “inverse cumulative probability” line 455 of FIG. 18, approximately one hundred eighty five (or more) candidates are needed to apply for the job in order for the probability of filling the job with a desirable candidate to be high. Similar numbers are shown for each stage of the hiring process. For example, FIG. 18 shows that there is an 11.25% chance that an individual in the phone interview stage will move on to a job offer. The inverse of this number shows that about nine (or more) candidates need to be passed on to the phone interview stage for there to be a high likelihood that the position will be filled.

As shown in step 612 of FIG. 17, after calculating the cumulative probabilities for the hiring process, the system displays the appropriate status lights 530 on the HR openings page 502 (as discussed above with reference to FIG. 14). To this end, the system compares the calculated probability numbers with the number of actual candidates in various stages of the hiring process. The system also compares the average duration times with the total number of days remaining until the job must be filled. If the system detects that there are not enough applicants or there is not enough time for all applicants to move through the hiring process before the deadline, a yellow or red status light 530 is displayed. Typically, a yellow status light is first displayed when the system initially detects a moderate risk of not filling the job by the deadline. The yellow status light then turns to a red status light when the system detects a high risk of not filling the job by the deadline.

Returning to the example of FIG. 18, row 460 provides a theoretical example of a situation where two hundred people applied for the job opening. In this example, the number of people in each remaining step is determined by the probability of candidates passing from one step to the next. Thus, row 460 shows the total number of applicants the system anticipates passing each hiring stage based on the total number of applicants applying for the opening. Row 470 of FIG. 18 provides an example of what the actual data related to a job opening might look like. In this example, two hundred candidates have applied for the job and thirty have passed onto the on-line testing stage. Seven of those candidates moved on to the phone interview stage and, of those seven, five candidates moved on to the interview stage. None of the candidates have been passed on to the background check stage. As noted in row 475, the typical number of days to reach the end of the hiring process from each stage is shown. At the start of the hiring process, twenty-two days are typically required to move a candidate from start to finish in the hiring process. This twenty two day number is simply the aggregate number of from the duration line, which shows the typical number of days to pass from stage to stage.

As mentioned previously, one example of a situation where a warning may be given with the status lights 430 is when there is a likelihood that an insufficient number of candidates exist at some stage to fill a job. In the example of line 470 of FIG. 18, the system would compare the number of candidates in each stage to the minimum desired number of candidates listed in line 455. In the application stage and the test stage, the number of candidates in line 470 is greater than the minimum desired number in line 455. Thus, the system would not indicate any status light warning for these numbers. However, only seven candidates are listed in the phone interview stage for line 470, which is less than the minimum number of nine or more for this stage in line 455. Therefore, this low number may cause the system to indicate a yellow status indicator for the job opening. If the actual number of candidates in the phone interview stage were significantly lower, such as two, the system may display a red status indicator to suggest that the potential problem is even more urgent. However, five candidates are listed in line 470 in the interview stage, which is equal to the minimum number for this stage in line 455. Accordingly, depending upon the configuration of the system, the system may determine that this acceptable number in the later stages of the hiring process removes the need for the warning related to a low number in an earlier stage of the process. Accordingly, the system is operable to provide a warning when there are likely to be an insufficient number of candidates to fill an open job position. Of course, if a job was recently posted in the system and the deadline for filling the job is months away, there are likely to be very few candidates that have applied for the job. Therefore, the system may be configured such that a warning is only indicated if the deadline for filling the job is within a relatively short amount of time, such as within one month or at the half-way point between job posting and deadline to fill the job. Until twenty percent of the time between a job posting and the job deadline has passed, no status lights 530 may be shown, or the status light may only show as green.

Another example of a situation where a warning may be indicated with the status lights 530 is when the deadline is likely to be insufficient time to pass the current candidates through the hiring process. In the example of FIG. 18, line 480 indicates that only eleven days are left before the deadline. Line 470 indicates that a sufficient number of candidates are in the interview stage to produce a likely hire, however, line 475 indicates that fifteen days are typically required to pass such candidates through the interview stage. Based on the eleven days remaining before the deadline, there is a likelihood that all of these candidates will not be properly interviewed and receive a background check (if appropriate) before the deadline. Therefore, the system will indicate a warning for the job with the status lights 530. The warning may be a yellow light warning indicating that the interview process should be accelerated or the best hire may not emerge before the deadline. A red warning light would indicate that the matter is even more urgent, such as if only five days remain before the deadline.

Another example of a situation where the system may be configured to provide a warning with the status lights 530 is when a highly ranked candidate is unlikely to reach the end of the hiring process before the deadline or before a lower ranked candidate is offered the job. Accordingly, the system monitors the progress of highly ranked candidates through the hiring process. Highly ranked candidates may be defined by the system, such as those candidates ranked in the top ten of all applicants for a job opening, or those candidates ranked in the top five percent of all applicants for a job opening. When monitoring the progress of highly ranked candidates, the system anticipates when a highly ranked candidate may take more time to move through the hiring process than the time remaining before the hiring deadline. The system is operable to anticipate these situations based on the typical duration times for the various hiring stages that are calculated by the system, as discussed above. If the system anticipates that a highly ranked candidate may not move through the hiring process before the hiring deadline, a red or yellow status light warning appears. When such a warning appears, the system instructs the HR department to fast track the highly ranked candidate through the hiring process.

Another way the system monitors highly ranked candidates through the hiring process is to make sure that lower ranked candidates do not receive job offers before higher ranked candidates are more fully evaluated. Accordingly, when a candidate passes the background stage, or some other late stage in the hiring process that precedes an offer, the system is configured to check for highly ranked (or higher ranked) candidates in earlier stages of the hiring process. If such candidates are detected, the system displays a red or yellow status light on the HR openings page 502 next to the job listing. This warning light indicates that an offer should not be made for the job before further evaluation is made on the highly ranked (or higher ranked) candidate. HR may then make a decision whether to proceed with the offer or to investigate the other candidate in further detail.

Yet another situation where the system provides a warning with the status lights 530 is when a highly ranked candidate has been in the background stage, offer stage, or other stage for an unacceptable duration. This unacceptable duration is typically a predetermined amount of time past which a highly ranked candidate may become frustrated if no additional action has occurred. For example, if a highly ranked candidate participated in the interview process more than ten days earlier, but has not received an offer or invite back for a second interview, the highly ranked candidate may believe that the organization is not interested. In these situations, the system is configured to provide a yellow or red status light warning the organization to provide additional communication to the highly ranked candidate or take further action on the highly ranked candidate before the candidate gives up on the job.

Based upon the above description, it can be seen that one desirable feature would be to provide additional information to the user about the warming provided with a status light. To this end, if the user clicks on a red or yellow status light 530 from the HR openings page 502 of FIG. 14, detailed information is provided concerning the reason for the warning. In particular, a pop-up window appears in the user's workspace explaining the reason for the warning.

Open Content With Integration at Any System Node

As mentioned above, the system 100 is operable to cooperate with third party content providers, such as third party content providers capable of providing professional testing. If the data is provided from the third party content provider in the same format used by the system there is no need for translation. However, the system 100 does not require the data in a certain format. Instead, the system includes a plurality of translation algorithms operable to transfer data from various third party formats (e.g., HTML, CLDR, SGML) into the format used by the system (e.g., XML). Thus, the system is an open system capable of seamless cooperation with numerous third party data providers.

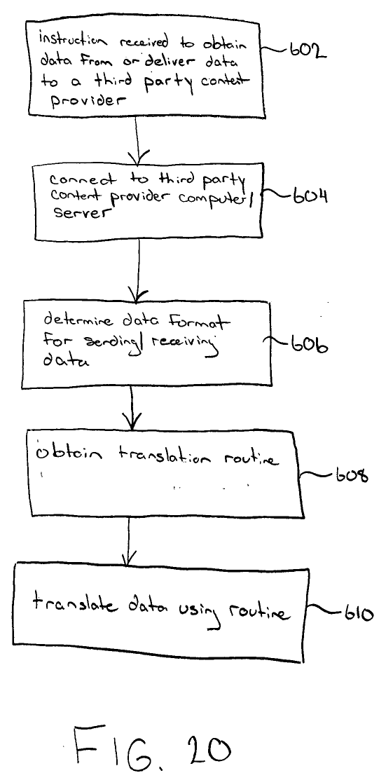

FIG. 20 shows a flowchart of the actions taken by the system to cooperate with third party content providers. As shown in the flowchart, when requested in step 602 to obtain data from or share data with a third party content provider, the central computer 101 connects to a designated third party computer/server 112 that will provide or receive the data using the Internet, as noted in step 604. After establishing a connection with such computer 112, the central computer 101 determines in step 606 the data format in which the third party computer will send data or wishes to receive data. With this information in hand, in step 608 the central computer pulls the appropriate data translation tool into memory and, in step 610, uses the tool to translate data being sent and received.

In addition to providing an open system capable of communicating with multiple third party content providers, the system is also operable to be configured as an open node at any step of the hiring process. An open node is a node in which the system is operable to send data to or receive data from third party content providers, regardless of content format. For example, in node 124 of FIG. 1, the system may receive a standardized test from a third party and/or receive test scores from such third party. However, in node 130 the system may communicate with a different content provider to automatically request a background check on a candidate and subsequently receive information from the content provider concerning the candidate's background. As another example, in step 132, the system may be configured to automatically contact a drug testing organization and, using the system scheduler, schedule a drug test for the candidate. After the drug test is complete, the results of the drug test may be sent to the HR department electronically and associated with the candidate in the system. Which nodes in the hiring process are operable to contact third party content providers may be modified by the company based on different jobs. For example, one job may require a drug screen while another job may not. Accordingly, the system is not only configured as open to third party content, but different nodes of the hiring process may be configured as open to third party content, depending upon the job opening.

Dynamic/Open Process

In one alternative embodiment of the system, the central computer is operable to automatically adjust an applicant's path through the hiring process. In this embodiment, one applicant's path through the hiring process may be different from another applicant's path. According to this embodiment, the central computer is operable to analyze data about each particular applicant and, where appropriate, transform the applicant's path during the hiring process. For example, with reference to FIG. 1, consider a job where the deductive reasoning skills of the applicant are crucial. Accordingly, the online test score for the applicant is heavily weighted. If a particular applicant scores exceptionally well in the online test stage 124, such that his or his score exceeds a predetermined threshold score, the system may automatically pass the applicant past the phone interview stage 126 and directly to the in-house interview stage 128. As another example, if it is preferable but not required for a certain job to be filled by a candidate having a particular degree, candidates having the desired degree may not be required to pass an online test stage.

Of course, the system may be configured with any number of rules to modify an applicant's path based upon certain information decided about the applicant. Certain rules may add additional stages, or sub-stages, and other rules may allow the applicant to skip stages to fast track the applicant through the hiring process. Accordingly, the system provides the organization with the flexibility to have a dynamic and open hiring process where the hiring process is modified for each applicant based upon the applicant's qualifications or performance during the hiring process.

Applicant Cross-Selling

Another particularly advantageous embodiment of the system described herein includes the ability to identify a candidate that has applied for a particular job opening and, based upon the applicant's scores from different stages of the hiring process, automatically identify such applicant as particularly desirable for a different job opening. To this end, for each job created in the system, a target set of characteristics may be identified. For example, for a certain sales position, the system may identify an individual with a college degree, high self confidence, good communication skills, and a high customer service orientation as being particularly suited for the position. If an applicant with these characteristics applies for a technical position, the system will automatically analyze the applicant's scores from various stages of the hiring process and identify the individual as well suited for the open sales position. If the system then recognizes that the individual's scores would rank the individual relatively high relative to other applicants for the sales position, the system will send the applicant an automatic message informing the applicant that, based on his or her scores, he or she may also want to apply for the open sales position. Depending upon the configuration of the system, this message may be sent regardless of whether the applicant is highly ranked for the technical position. Accordingly, the system periodically compares the individual profiles and scores for all candidates in the system with the target characteristics for available job openings. When individuals are identified that have not applied for jobs for which they may be interested and for which they would otherwise be highly ranked, the system provides an automated process for contacting these individuals to see if there is an interest in the other job opening. With this process in place, the system is capable of automatically identifying well qualified and highly qualified individuals, and contacting such individuals about potential jobs with the organization.

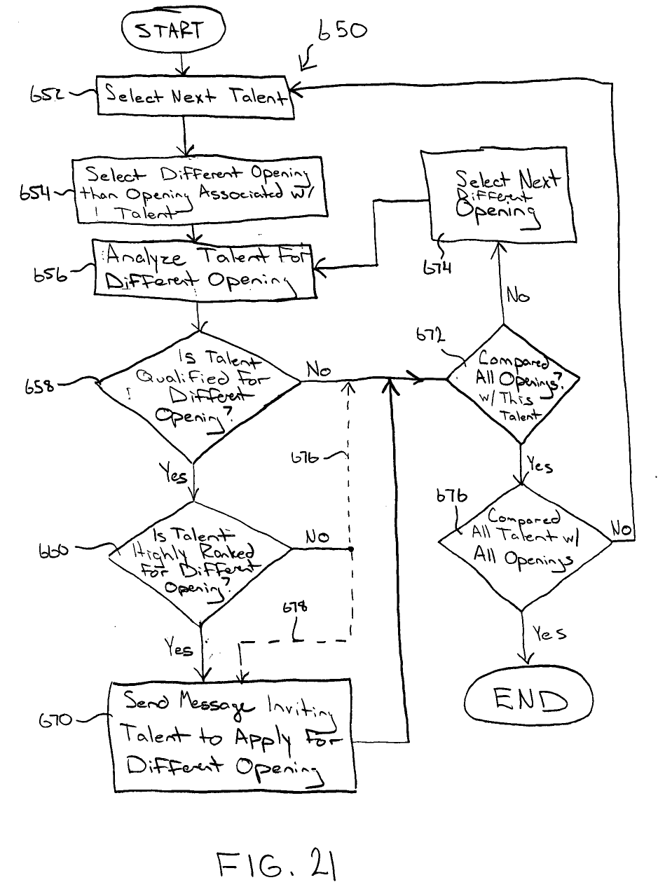

An exemplary flow chart of an exemplary subroutine used by the system for cross-selling applicants for additional job openings is provided in FIG. 21. The system periodically calls on subroutine 650 to determine if any applicants in the system might be well suited for job openings in the system other than those the jobs the applicants have applied for. Beginning in step 652, the system selects a job applicant (i.e., “talent”) and then in step 654 selects a different opening than the opening that the applicant has applied for. Next, in step 656, the system analyzes the candidate as if he or she has applied for the different opening. In step 658, the system decides whether the candidate is qualified for the different opening. Deciding whether the candidate is qualified may also involve an analysis of whether the candidate is over-qualified for the opening. If the talent is qualified for the different opening, the system goes to step 660. If not, the system goes to step 672. In step 660, the system decides whether the candidate is highly ranked for the different opening. If the candidate is highly ranked, in step 670 the system sends a message to the candidate through his or her workspace indicating that the candidate may be interested in a different position. If the candidate is not highly ranked, the system may or may not send such a message, as indicated by dotted lines 676 and 678. After making a determination for one opening, the system decides in step 672 whether to compare additional openings. If additional openings are to be compared, the system moves to step 674, selects a different opening, and repeats the process of analyzing the candidate with this different opening. On the other hand, if the system has compared all available openings for the candidate, in step 676, the system decides whether additional candidates should be analyzed with respect to different openings. If additional candidates need to be analyzed, the process is repeated for the additional candidates. If not, the subroutine ends.

Accordingly, the system includes an advantageous feature that periodically analyzes all candidates to see if they might be interested in other positions within the organization. This feature allows the system to identify applicants already within the system that may be very useful in other areas of the organization, even though such candidates have applied for a position in a different area. Accordingly, other job openings may be filled by well qualified candidates at a faster pace, as the most highly qualified candidates are identified and an attempt is made to cross-sell such candidates to other job openings, when appropriate. Of course, additional or different rules may be included to make sure the system does not distract highly ranked applicants from the jobs they have applied for. For example, the system may only apply to candidates that are not ranked in the top two for a particular opening. Furthermore, the feature may automatically remove a candidate from analysis with respect to other positions when the candidate passes a certain stage in the process and it appears that he or she will be offered a job they have already applied for.

Various Embodiments Possible

Although the present invention has been described with respect to certain preferred embodiments, it will be appreciated by those of skill in the art that other implementations and adaptations are possible. For example, although the above- described system has been explained with reference to hiring of candidates, the system is generally useful in evaluating talent and performance in any number of different fields. For example, the system could be used in an academic environment. Furthermore, the system could be expanded to track the progress of recently hired employees through a training process. The above-described system could also be modified to allow the user to deliver workforce surveys to its employees, track the completion of the surveys, and review the results of the surveys. Moreover, there are advantages to individual advancements described herein that may be obtained without incorporating other aspects described above. For example, the scheduler may be useful in certain applications where the job fill probability indicator is not useful. Therefore, the spirit and scope of the appended claims should not be limited to the description of the preferred embodiments contained herein.

What is claimed is:

1. A human resources system for providing information to an organization employee at a network computer concerning a job opening having a plurality of hiring stages and a related plurality of job applicants, the system comprising:
a) at least one memory containing data related to the job opening, the plurality of hiring stages, and the plurality of job applicants;
b) a central computer communicating with the at least one memory and the at least one network computer, the central computer operable to determine whether a warning situation exists related to the job opening and provide an employee workspace accessible by the employee at the at least one network computer, the employee workspace operable to
i) display the job opening; and
ii) provide a warning associated with the displayed job opening when the central computer determines that the warning situation exists.

2. The system of claim 1 wherein the central computer is operable to determine a probability of passing through the plurality of hiring stages, and wherein the warning situation comprises an insufficient total number of the plurality of job applicants such that a likelihood exists that at least one of the plurality of job applicants will not pass through the plurality of hiring stages.

3. The system of claim 1 wherein the central computer is operable to track a typical time to pass through the plurality of hiring stages, and wherein the warning situation comprises a likelihood that one of the plurality of job applicants will have insufficient time to pass through the plurality of hiring stages before a deadline.

4. The system of claim 1 wherein the central computer is operable to rank each of the plurality of job applicants and is operable to track a typical time to pass through the plurality of hiring stages, and wherein the warning situation comprises at least one highly ranked candidate that is likely to not complete the hiring process unless the highly ranked candidate is fast tracked through the hiring process.

5. A method for monitoring the status of a job opening within an organization, wherein the job opening is to be filled by one of a plurality of applicants, the method comprising:
a) defining a plurality of hiring stages for completion by each of the plurality of applicants;
b) for each of the plurality of hiring stages, determining a probability of passing the hiring stage; and
c) determining whether the job opening is likely to be filled by one of the plurality of applicants based on a total number of the plurality of applicants and the probabilities of passing each of the plurality of hiring stages.

6. The method of claim 5 further comprising, for each of the plurality of hiring stages, determining a cumulative probability of passing the remaining hiring stages of the plurality of hiring stages.

7. The method of claim 6 further comprising the step of calculating the inverse of at least one of the cumulative probabilities.

8. The method of claim 7 further comprising the step of comparing the inverse of the at least one of the cumulative probabilities to the total number of the plurality of applicants.

9. The method of claim 7 further comprising the step of comparing the inverse of the at least one of the cumulative probabilities to a total number of a subset of the plurality of applicants who have passed one of the plurality of hiring stages.

10. The method of claim 5 further comprising the step of displaying a warning symbol if it is determined that the job opening is not likely to be filled by one of the plurality of applicants.

11. A method for monitoring the status of a job opening within an organization, wherein the job opening is to be filled by one of a plurality of applicants, the method comprising:
a) defining a plurality of hiring stages for completion by each of the plurality of applicants;
b) for each of the plurality of hiring stages, determining a typical time that applicants remain in the hiring stage; and
c) determining whether an insufficient amount of time is available to identify one of the plurality of job applicants for the job opening.

12. The method of claim 11 wherein the step of determining whether an insufficient amount of time is available is based on a deadline to fill the job opening.

13. The method of claim 12 further comprising the step of, for each of the plurality of hiring stages, determining a probability of passing the hiring stage

14. The method of claim 11 wherein the one of the plurality of job applicants is a highly ranked candidate and wherein the step of determining whether an insufficient amount of time is available is based on the existence of another of the plurality of job applicants passing through a later stage of the plurality of hiring stages when the highly ranked candidate remains in an earlier stage of the plurality of hiring stages.

15. The method of claim 14 further comprising the step of accelerating the highly ranked candidate through the stages of the hiring process.

16. A method for monitoring the status of a job opening within an organization, wherein the job opening is to be filled by one of a plurality of applicants, the method comprising:
a) defining a plurality of hiring stages for completion by each of the plurality of applicants;
b) maintaining statistical information related to the job opening;
c) determine whether a warning situation exists related to the job opening based on the statistical information related to the job opening; and
d) displaying a warning associated with the job opening if it is determined that a warning situation exists.

17. The method of claim 16 wherein the statistical information comprises a probability that a job applicant will pass through the plurality of hiring stages, and wherein the warning situation comprises an insufficient total number of the plurality of job applicants such that a likelihood exists that at least one of the plurality of job applicants will not pass through the plurality of hiring stages.

18. The method of claim 16 wherein the statistical information comprises a typical time to pass through the plurality of hiring stages, and wherein the warning situation comprises a likelihood that one of the plurality of job applicants will have insufficient time to pass through the plurality of hiring stages before a deadline.

19. The method of claim 16 wherein the statistical information comprises a rank for each of the plurality of job applicants and a typical time to pass through the plurality of hiring stages, and wherein the warning situation comprises a likelihood that at least one highly ranked candidate will have insufficient time to pass through the plurality of hiring stages unless the highly ranked candidate is fast tracked through the hiring process.
